(19) United States
(12) Patent Application Publication
(10) Pub. No.: US 2025/0340161 A1
(43) Pub. Date: Nov. 6, 2025

(54) Built-In Ramp System for Vehicle

(71) Applicant: North American Ramps LLC, Charlotte, NC (US)

(72) Inventor: Earl Robert Ernsberger, IV, Charlotte, NC (US)

(73) Assignee: North American Ramps LLC, Charlotte, NC (US)

(21) Appl. No.: 19/198,614

(22) Filed: May 5, 2025

Related U.S. Application Data
(60) Provisional application No. 63/642,022, filed on May 3, 2024.

(51) Int. Cl. B60P 1/43

(52) U.S. Cl. CPC B60P 1/435

(57) ABSTRACT

A frame assembly for a vehicle with a built-in ramp includes a frame including a first leg extending between a first end and a second end, a second leg extending between a first end and a second end, and a bridge extending between the first end of the first leg and a first end of the second leg. Each of the first and second legs extend from an inner surface to an outer surface. The inner surface is configured to abut a body of the vehicle, and the outer surface is configured to abut a foldable ramp when the ramp is in a closed configuration. The outer surface of each of the first and second legs is substantially planar, and the inner surface of each of the first and second legs is tapered such that the inner surface is contoured to the body of the vehicle.

### CROSS-REFERENCE TO RELATED APPLICATIONS

This application claims the benefit of the filing date of U.S. Provisional Patent Application No. 63/642,022 filed May 3, 2024, the disclosure of which is hereby incorporated herein by reference.

### BACKGROUND OF THE INVENTION

A variety of vehicle ramp systems exist in the marketplace, such as manual or portable ramps, fold-away ramps, and hydraulic ramps, each of which may have certain benefits, but also several drawbacks. For example, portable ramps need to be strapped down during transport, tend to be bulky and take up valuable cargo space, and may be unstable causing significant paint and metal damage as they tend to move while in use during loading and unloading. Additionally, portable ramps typically do not offer a way to be secured to the vehicle, particularly for securing to and onto the chassis. Moreover, the risk of injury to the user, and/or the risk of damage to equipment is significantly increased due to the lack of securement. Fold-away ramps similarly take up valuable cargo space in the interior of the vehicle, can be limited in width to fit within the vehicle, and may be limited in weight capacity. All of which limits what type of equipment can be loaded and or unloaded into the vehicle. Because fold-away ramps are mounted inside the van, the weight of the fold-away ramp system must be reduced in order to provide the user with the ability to fold the ramp back into position with case-of-use and safety. The heavier the ramp, the greater the difficulty is exacerbated. The lighter the ramp, the easier it is to fold back into position. Another functional issue relates to the weight of the fold-Away ramp system. Simply put, the lighter the weight of the ramp yields less weight capacity to the user and the specific type of equipment that can be loaded and or unloaded. Additionally, the only way to increase the load capacity of the ramp is to add legs for stability underneath the fold-away ramp system. The issue with adding legs is that the ramp, regardless of the legs, has a weight rating specific to its thickness and grade of metal. Adding legs will not change the weight rating of the ramp itself, it simply adds support, not weight capacity. Hydraulic ramps are typically more expensive, and must be mounted outside of the vehicle where they are exposed to the elements. They also can require significant effort and expense for installation, are exposed to greater risk of malfunction, and add significantly more weight to the vehicle. Because hydraulic ramp systems are much heavier, the added weight to the rear of the vehicle (especially cargo vans), can make driving the vehicle hazardous due to swaying.

A foldable ramp system integrated into a vehicle offers several advantages over traditional ramp designs. However, this concept is still in the early stages of development, with existing designs leaving room for significant improvements in functionality. Notably, enhancements can be made in areas such as the structural integrity and installation of the ramp onto the vehicle chassis to improve weight capacity, stability, and the hinged movement of the ramp, among other factors.

An improved design of a vehicle with a built-in ramp system is needed to address various issues and drawbacks in previous designs. For example, in previous designs, the frames may not fit correctly, bumpers may not be fit back onto the van chassis, mounting tabs which were manufactured as fixedly coupled to the frame may be bent during transit, and the galvanizing on the frames may rust, among other issues. Previous frame designs may have been prone to stress and could easily break and may have also failed to prevent water from penetrating the frame and entering the vehicle. Previous designs may have experienced premature warping as the frame would weaken over time with the opening and closing of the ramp system. As such, an updated and modified system is needed to resolve the issues and drawbacks posed by the previous system designs.

### BRIEF SUMMARY OF THE INVENTION

According to a first aspect of the disclosure, a frame assembly for a vehicle with a built-in ramp may include a frame including a first leg, a second leg, and a bridge. The frame may be configured to bound an opening of a vehicle. The first leg may extend between a first end and a second end. The second leg may extend between a first end and a second end. The bridge may extend between the first end of the first leg and the first end of the second leg. Each of the first and second legs may extend from an inner surface to an outer surface. The inner surface may be configured to abut a body of the vehicle, and the outer surface may be configured to abut the a built-in ramp when the ramp is in a closed configuration. The outer surface of each of the first and second legs may be substantially planar. The inner surface of each of the first and second legs may be tapered such that the inner surface is contoured to the body of the vehicle.

Further in the first aspect of the disclosure, the inner surface and the outer surface of the first and second legs may be separated by a depth of the first and second lengths extending in a front-rear direction when the frame assembly is coupled to the vehicle. The first leg may include an upper tapered portion, a central portion adjacent and below the upper tapered portion, and a lower tapered portion adjacent and below the central portion. The inner surface of the first leg may taper toward the outer surface as the first leg extends from the upper tapered portion toward the central portion. The inner surface of the first leg may taper toward the outer surface as the first leg extends from the lower tapered portion toward the central portion. The first leg may include an upper tapered portion, a central portion below the upper tapered portion, and a lower tapered portion below the central portion, and the central portion may have a depth defined in a front-rear direction. The depth of the central portion may be less than a depth of the upper and lower tapered portions.

Further in the first aspect of the disclosure, each of the first leg, the second leg, and the bridge may be formed with a first frame segment extending along a height of the first and second legs and a width of the bridge. The first frame segment may be coupled to a second frame segment extending along the height of the first and second legs and the width of the bridge and may be coupled to the first frame segment to form an L-shaped joint. A cross-section of the first leg along a horizontal plane may define the L-shaped joint between the first and second frame segments, and a cross-section of the bridge along a vertical plane may define the L-shaped joint between the first and second frame segments. The L-shaped joint may define an interior slot between the first frame segment and the second frame segment, and at least one tab may be affixed to the first and second frame segments within the interior slot.

Further in the first aspect of the disclosure, the frame assembly may include a flange configured to be coupled to an upper surface of the bridge of the frame. The flange may be configured to extend in a rearward direction from the frame and an upward direction from the frame. The frame may further include a lower plate opposite the bridge extending between the first leg and the second leg. The lower plate may include an inner surface configured to extend substantially parallel to a floor of the vehicle, and the lower plate may further include an outer surface extending oblique to the inner surface, such that the inner surface and the outer surface meet to define an outer edge. The inner surface of the lower plate may include an inner edge configured to be positioned adjacent the floor of the vehicle, and the inner edge may be beveled toward a plane on which the floor extends when the lower plate is coupled to the vehicle to form a smooth transition between the floor and the inner surface.

According to a second aspect of the disclosure, a vehicle with a built-in ramp may include a vehicle body, a ramp, and the frame as described in the first aspect of the disclosure. The vehicle body may extend from a front end to a rear end. The vehicle body may define an opening spanning between an upper edge of the vehicle body and a lower edge of the vehicle body. The ramp may be hingedly connected to the rear end of the vehicle body. The ramp may be configured to transition between an open configuration and a closed configuration. In the open configuration, the ramp may protrude in a rearward direction from the vehicle body. In the closed configuration, the ramp may be in contact with the upper edge of the vehicle body and the lower edge of the vehicle body and may span across an entirety of the opening.

According to a third aspect of the disclosure, a frame assembly for a vehicle with a built-in ramp may include a frame, a lower plate, a pivot dock, a frame bar, a spring torsion bar, and a cam pin. The frame may include a first leg, a second leg, and a bridge extending between the first leg and the second leg. The lower plate may extend between the first leg and the second leg. The pivot dock may be pivotably coupleable to the frame and the pivot dock may define a cavity extending therethrough. The frame bar may be configured to be fastened to the frame and the pivot dock and may define an aperture for receiving a spring torsion bar therethrough. The spring torsion bar may be configured to be positioned with the cavity of the pivot dock. The cam pin may be configured to be positioned within the cavity of the pivot dock. The cam pin may have a first rounded surface and a second rounded surface opposite the first rounded surface. The cam pin may further have a first planar surface connecting the first and second rounded surfaces and a second planar surface opposite the first planar surface and connecting the first and second rounded surfaces.

Further in the third aspect of the disclosure, the lower plate may include an inner surface configured to extend substantially parallel to a floor of the vehicle when the frame assembly is coupled to the vehicle. The lower plate may further include an outer surface extending oblique to the inner surface, such that the inner surface and the outer surface meet to define an outer edge. The lower plate may include a lower mounting bracket configured to abut a body of the vehicle when the frame assembly is coupled to the vehicle. The lower mounting bracket may extend in a rearward direction from the outer surface of the lower plate when the frame assembly is coupled to the vehicle and in a downward direction from the inner surface of the lower plate when the frame assembly is coupled to the vehicle, and the lower mounting bracket may define a notch on an upper-rear corner of the lower mounting bracket.

Further in the third aspect of the disclosure, the cam pin may be a female cam pin defining a socket therein configured to receive the spring torsion bar, and the frame assembly may further include a male cam pin configured to be coupled to the pivot dock on a side of the pivot dock opposite that of the female cam pin. The pivot dock may include a first protrusion extending a first distance from the cavity and the pivot dock may include a second protrusion extending a second distance from the cavity. The second distance may be greater than the first distance, and the first and second protrusions may extend parallel to one another and may define a slot therebetween configured to receive a panel of the foldable ramp. The aperture defined by the frame bar may be a first aperture, and the frame bar may further define a second aperture sized and shape to receive a latch configured to lock the ramp in the closed configuration. The frame bar may define a plurality of orifices sized and shape to receive a fastener for coupling the frame bar to the frame, and a perimeter of each of the first aperture, the second aperture, and the plurality of orifices may be beveled. The cavity of the pivot dock may be substantially cylindrical, and the cavity may include a plurality of grooves configured to receive the spring torsion bar, each of the plurality of grooves may substantially form a right angle.

According to a fourth aspect of the disclosure, a vehicle with a foldable ramp may include a vehicle body, a ramp, and a frame assembly as described above with respect to the third aspect of the disclosure. The vehicle body may extend from a front end to a rear end. The vehicle body may define an opening spanning between an upper edge of the vehicle body and a lower edge of the vehicle body. The ramp may be hingedly coupled to the rear end of the vehicle body. The ramp may be configured to transition between an open configuration and a closed configuration. In the open configuration, the ramp may protrude in a rearward direction from the vehicle body. In the closed configuration, the ramp may be in contact with the upper edge of the vehicle body and the lower edge of the vehicle body and may span across an entirety of the opening.

According to a fifth aspect of the disclosure, a vehicle with a built in ramp may include a vehicle body, a ramp, and a frame. The vehicle body may extend from a front end to a rear end. The vehicle body may define an opening spanning between an upper edge of the vehicle body and a lower edge of the vehicle body. The ramp may be hingedly coupled to the rear end of the vehicle body. The ramp may be configured to transition between an opening configuration and a closed configuration. In the open configuration, the ramp may protrude in a rearward direction from the vehicle body. In the closed configuration, the ramp may be in contact with the upper edge of the vehicle body and the lower edge of the vehicle body and may span across an entirety of the opening. The frame may bound the opening. The frame may include a first leg, a second leg, and a bridge extending between the first and second legs. Each of the first and second legs may extend from an inner surface to an outer surface. The inner surface may be configured to abut the vehicle body, and the outer surface may be configured to abut the ramp when the ramp is in the closed configuration. The outer surface of each of the first and second legs may be substantially planar. The inner surface of each of the first and second legs may be tapered such that the inner surface is contoured to the vehicle body.

Further in the fifth aspect of the disclosure, the vehicle may further include a ramp extension pivotably coupled to an outer end of the ramp. When the ramp is in the open configuration, the ramp extension may be coplanar with the ramp, and when the ramp is in the closed configuration, the ramp may extend in a first plane and the ramp extension may extend in a second plane spaced from and parallel to the first plane. The ramp may include at least a first and a second ramp panel, and each of the first and second ramp panels may include a locking side and a receiving side opposite the locking side. The locking side may include a protrusion and the receiving side may define a slot sized and shape to receive the protrusion. Each ramp panel may include an inner sheet extending along a first plane and an outer sheet extending along a second plane parallel to the first plane. Each ramp panel may further including at least one rib extending between the inner and outer sheets and along a length of the ramp panel.

Further in the fifth aspect of the disclosure, the inner sheet of each ramp panel may include a first protrusion on the locking side of the ramp panel extending along the length of the ramp panel. The inner sheet of each ramp panel may includes a generally C-shaped portion extending along the length of the inner sheet and defining the slot for receiving the first protrusion of an adjacent ramp panel. The outer sheet of each ramp panel may include a first lip on the locking side extending along the length of the outer sheet, and the outer sheet may include a second lip on the receiving side extending along the length of the outer sheet. The first lip may be configured to engage with the second lip of the adjacent ramp panel to affix the adjacent ramp panels together. The vehicle may further include adjustable legs extending in a downward direction from an outer surface of the ramp when the ramp is in the open configuration.

### BRIEF DESCRIPTION OF THE DRAWINGS

FIGS. 1A-1B are perspective views of a vehicle with a foldable ramp in closed and open configurations, respectively, according to a first embodiment of the disclosure.

FIG. 2A is a side view of a frame of the vehicle of FIG. 1A.

FIG. 2B is a perspective partial view of the frame of FIG. 2A installed into the vehicle of FIG. 1A.

FIG. 2C is a partial perspective rear view of the frame of FIG. 2A.

FIG. 2D is a rear perspective view of the frame of FIG. 2A installed in the vehicle of FIG. 1A.

FIG. 3 is a close-up view of a flange on the vehicle of FIG. 1A.

FIG. 4A is a perspective view of a lower plate installed on the vehicle of FIG. 1A.

FIG. 4B is a close-up view of the lower plate of FIG. 4A.

FIG. 4C is a top view of the lower plate of FIG. 4A installed on the vehicle of FIG. 1A.

FIG. 5 is an exploded view of the frame of FIG. 2A and mounting brackets.

FIG. 6A is a top view of the mounting brackets of FIG. 5.

FIG. 6B is a perspective view of the mounting brackets of FIG. 5 installed on the vehicle of FIG. 1A.

FIG. 6C is a perspective view of a mounting bracket according to another embodiment of the disclosure.

FIGS. 6D-6F are perspective views of fasteners included on the frame of FIG. 2A for coupling the mounting brackets of FIG. 5.

FIG. 7 is a perspective view of the frame of FIG. 2A coupled to the lower plate of FIG. 4A and the mounting brackets of FIG. 5.

FIG. 8A is a side view of a frame bar.

FIGS. 8B-8D are partial views of the frame bar of FIG. 8A.

FIGS. 9A-9B are perspective views of an upper mounting bracket of the vehicle of FIG. 1A.

FIG. 10A is a perspective bottom view of the frame of FIG. 2A.

FIG. 10B is a close-up view of a lower mounting bracket included on the frame of FIG. 10A.

FIG. 11 is a side view of a spring torsion bar.

FIGS. 12A-12B are perspective views of cam pins.

FIG. 12C is a perspective view of a cam pin according to another embodiment of the disclosure.

FIG. 12D is a perspective view of a cam pin according to another embodiment of the disclosure.

FIG. 13 is a perspective side view of a subassembly of a pivot dock, a ramp panel, and the spring torsion bar of FIG. 11.

FIG. 14A is a side perspective view of the pivot dock of FIG. 13.

FIG. 14B is a side perspective view of the pivot dock of FIG. 13 coupled to the ramp panel of FIG. 13.

FIGS. 15A-15D illustrate steps to installing the cam pin of FIG. 12C onto the torsion spring bar of FIG. 11 and into the pivot dock of FIG. 13.

FIG. 16A is a perspective view of a ramp panel of the ramp of the vehicle of FIG. 1A.

FIGS. 16B-16C are side partial views of the interlocking of two ramp panels.

FIG. 17 is a rear view of the vehicle of FIG. 1A including ramp handles, a latch bar, and a latch lock.

FIG. 18A is a perspective view of the interior anti-slip surface of the ramp of the vehicle of FIG. 1A.

FIG. 18B is a close-up view of the interior anti-slip surface of FIG. 18A.

FIG. 19A is a perspective side view of a ramp dock.

FIG. 19B is a perspective side view of the ramp dock of FIG. 19A coupled to the ramp panel of FIG. 16A.

FIG. 20 is a perspective view of the ramp of the vehicle of FIG. 1A including weather strips.

FIGS. 21A and 21B are perspective rear and side views, respectively, of a rear camera extension of the vehicle of FIG. 1A.

FIG. 21C is a perspective view of a rear camera extension according to another embodiment of the disclosure.

FIG. 22A is a perspective view of a ramp extension coupled to the ramp of the vehicle of FIG. 1A in the open configuration.

FIG. 22B is a perspective view of the ramp with the ramp extension of FIG. 22A in the closed configuration.

FIG. 23A is a perspective view of the ramp of the vehicle of FIG. 1A with legs coupled to an outer surface thereof.

FIG. 23B is a side perspective view of the legs of FIG. 23A.

### DETAILED DESCRIPTION

As used herein, the terms “about,” “generally,” “approximately,” and “substantially” are intended to mean that slight deviations from absolute are included within the scope of the term so modified. However, unless otherwise indicated, the lack of any such terms should not be understood to mean that such slight deviations from absolute are not included within the scope of the term so modified. It should be appreciated that like reference numerals refer to like elements throughout the disclosure.

It should be noted that any use of directional language (e.g., left, right, upper, lower, etc.) throughout this disclosure is intended to be interpreted from the point-of-view of a person positioned rearward of the vehicle and viewing the rear end of the vehicle. The use of directional language is merely used for ease of description and such terms are not intended to be limited to the directions described herein.

In a first aspect, a built-in ramp system is manufactured separately from a vehicle, and subsequently installed on the vehicle. For example, a vehicle may be constructed as it typically would with all doors, including a rear door, intact. The rear doors may then be removed to prepare the vehicle for installation of the built-in ramp system. However, it should be noted that the improvements described throughout the present disclosure can also be incorporated into a vehicle that is manufactured directly with a built-in ramp system, and this disclosure is not limited by the embodiments shown.

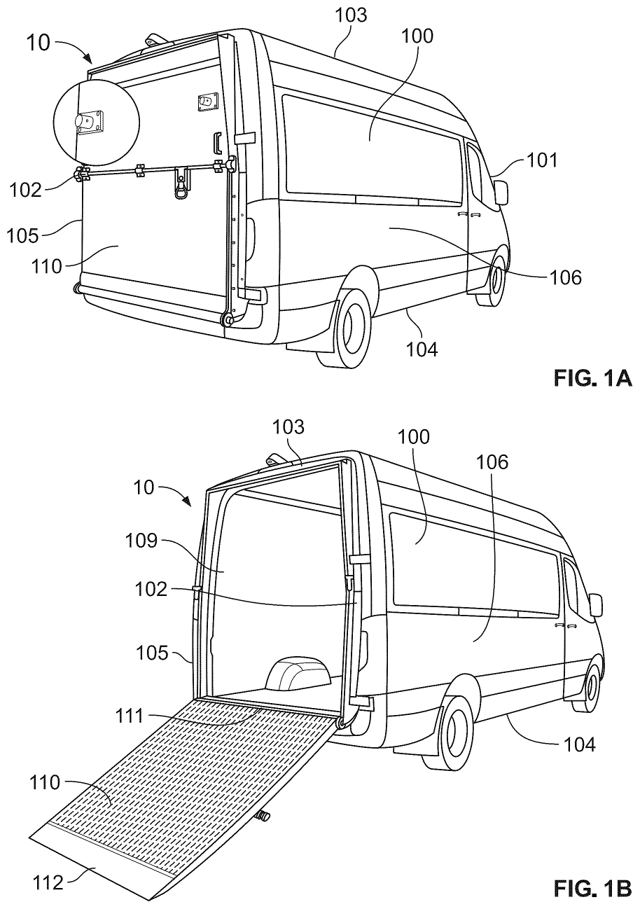

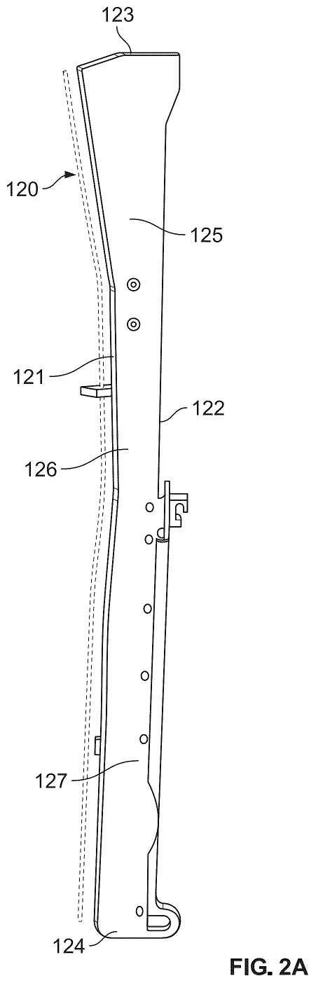

A first embodiment of a vehicle 10 with a built-in ramp system of the present invention is illustrated in FIGS. 1A-1B. The vehicle 10 may be, e.g., a cargo van, a truck, or the like. The vehicle 10 includes a body 100 (e.g., a chassis) which extends from a front end 101 to a rear end 102, from an upper end 103 to a lower end 104, and from a left side 105 to a right side 106. The body 100 defines an opening 109 at the rear end 102 as shown in FIG. 1B, the opening 109 spanning approximately from the upper end 103 to the lower end 104 and approximately from the left side 105 to the right side 106 of the body 100.

The vehicle 10 further includes a ramp 110 pivotably coupled to the rear end 102 of the vehicle which is configured to transition between a closed configuration as shown in FIG. 1A and an open configuration as shown in FIG. 1B. When the ramp 110 is in the closed configuration, the ramp 110 extends along a substantially vertical plane from the lower end 104 of the body 100 to the upper end 103 of the body 100. Furthermore, the opening 109 is entirely covered such that an interior space defined by the body 100 is enclosed to prevent any communication between the interior space and ambient elements such as wind, rain, debris, etc.

Referring to FIG. 1B wherein the ramp 110 is in the open configuration, the ramp 110 extends from an inner end 111 to an outer end 112. The inner end 111 is pivotably coupled to the body 100 approximately where the lower end 104 meets the rear end 102. The outer end 112 is a free end when the ramp 110 is in the open configuration and may contact an ambient surface, e.g., the ground. The ramp 110 extends in a rearward direction and a downward direction from the body 100 such that the ramp 110 is planar and sloped until the ramp 110 meets the ground. When the ramp 110 is in the closed configuration, the outer end 112 is coupled to the body 100 approximately where the upper end 103 meets the rear end 102 so that the ramp 110 spans across and covers an entirety of the opening 109.

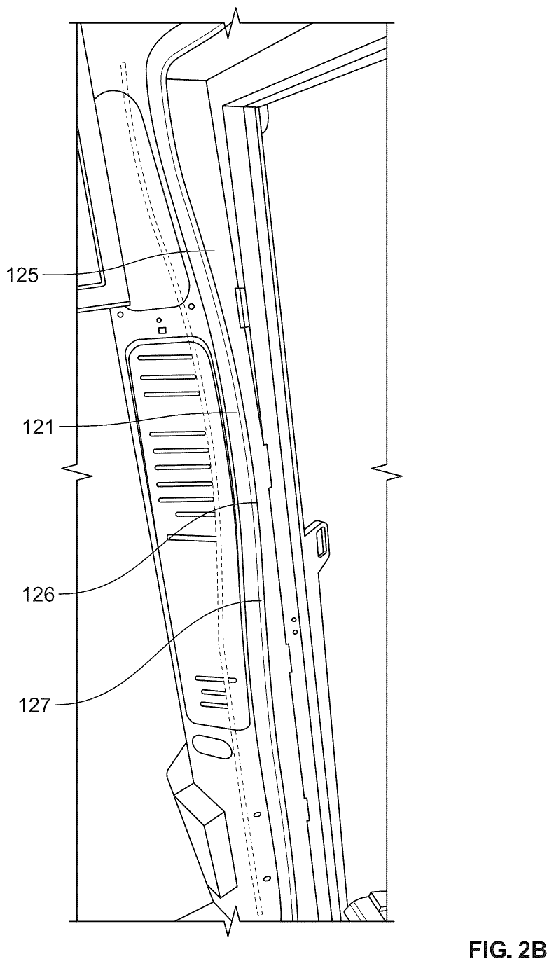

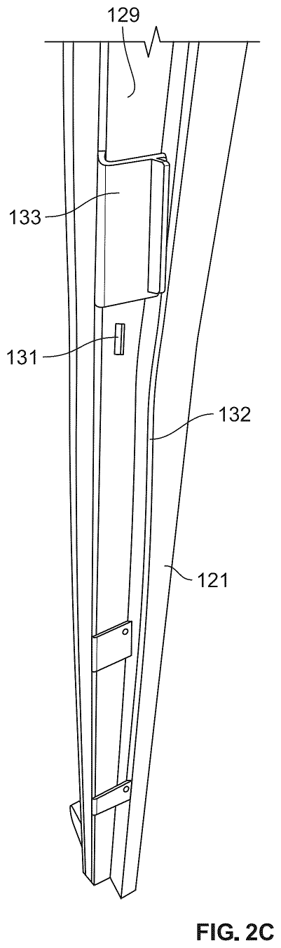

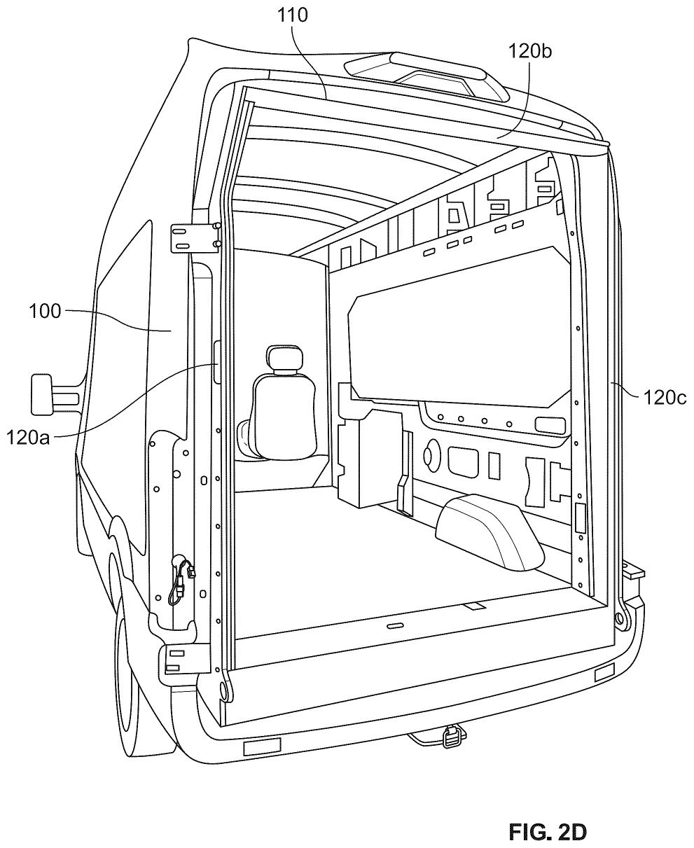

The ramp 110 is coupled to the body 100 by a frame 120, which is illustrated in FIGS. 2A-2F. The frame 120 includes a fist leg 120a, a second leg 120c, and a bridge 120b extending between the first and second legs 120a, 120b, as illustrated in FIG. 2D. When coupled to the body 100, the frame is positioned at the rear end 102 of the body 100 and generally extends vertically along the left side 105, horizontally along the upper end 103, and vertically along the right side 106. Referring to FIG. 2A, the frame 120 extends from an inner side 121 to an outer side 122, wherein the inner side 121 is configured to abut and couple to the body 100 and the outer side 122 is configured to abut and couple to the ramp 110. The frame 120 further extends from an upper end 123 to a lower end 124, wherein the upper end 123 of the frame 120 corresponds to the upper end 103 of the body 100 and the lower end 124 of the frame corresponds to the lower end 104 of the body 100.

The outer side 122 of the frame 120, particularly along the first leg 120a and the second leg 120c, is substantially planar, whereas the inner side 121 is sloped or tapered, forming upper tapered portion 125 and lower tapered portion 127. Thus, a depth (e.g., the distance between the inner side 121 and the outer side 122) varies along a height of the frame 120 due to the sloped inner side 121 along the upper tapered portion 125 and the lower tapered portion 127. The inner side 121 is sloped inward from the upper end 123 toward the central portion 126 and the inner side 121 is also sloped inward from the lower end 124 toward the central portion 126. Thus, the thickness of the frame 120 is smaller at the central portion 126 than the upper tapered portion 125 and the lower tapered portion 127.

The shape of the frame 120, particularly the inner side 121, is therefore contoured to the shape of the body 100 where the frame 120 is coupled to the body 100. The contoured frame promotes durability and case of installation. For example, the contour of the body 100 is where the original factory doors were in place on the vehicle 100 before the original doors were replaced with the ramp 110, and the contoured frame permits the manufacturer to leave the original factory weather stripping in place, which helps to mitigate water and fumes from entering the interior of the body 100. The frame 120 is illustrated coupled to the body 100 in FIGS. 2B and 2D.

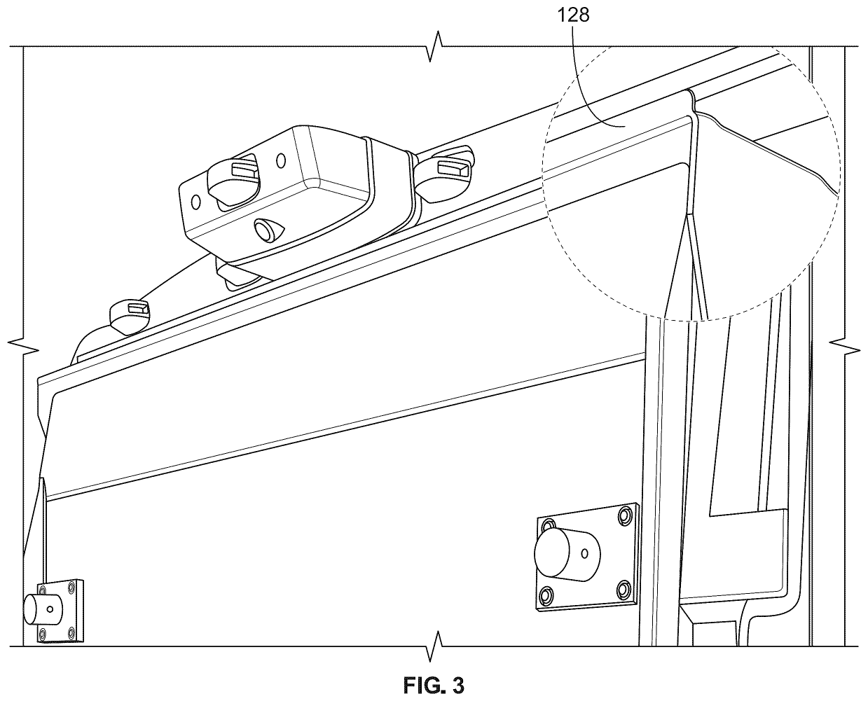

Furthermore, a width of the frame 120 (e.g., the distance between the left side and the right side) is increased compared to previous designs to improve overall strength and provide superior protection from the elements. Furthermore, a wider ramp allows larger types of equipment to be loaded and/or unloaded, provides the user with more platform space to maneuver equipment up and down the ramp, and provides more space to walk on and around the ramp providing additional safety for the user. Because an upper end 123 of the frame 120 was widened, the outer end 112 of the ramp 110 is covered when the ramp 110 is in the closed configuration which prevents rain and water from entering the interior of the body 100. Furthermore, the ramp includes flange 128 extending from the upper surface of the frame 120 as shown in FIG. 3. The flange 128 is generally L-shaped and prevents water from dripping over the upper end 123 of the frame 120 and instead channels the water along the sides of the frame 120.

Returning to FIG. 2C, the frame 120 defines a slot 129 along its height which is defined by an L-shaped joint formed along a length of the frame 120. For example, the L-shaped joint is formed by a first frame segment 131 extending along the height and in a thickness direction (e.g., from the left side to the right side of the first leg 120a) of the frame 120 and a second frame segment 132 extending along the height and protruding in a depth direction (e.g., from the front to the rear of the first leg 120a and perpendicular to the first frame segment 131). Such structure permits both the exterior and the interior of the frame 120 to be either powder-coated or galvanized on and throughout the entire frame 120 to protect the frame 120 from rust and corrosion, whereas it would not be possible to coat the interior of a tubular frame used in previous designs. The structure of the frame 120 offers greater strength than an angle-iron structure used in previous designs and still avoids the pitfalls of a tubular design as noted above. The frame further includes welded tabs 133 joining the first frame segment 131 and the second frame segment 132 to improve strength and durability of the L-shaped joint.

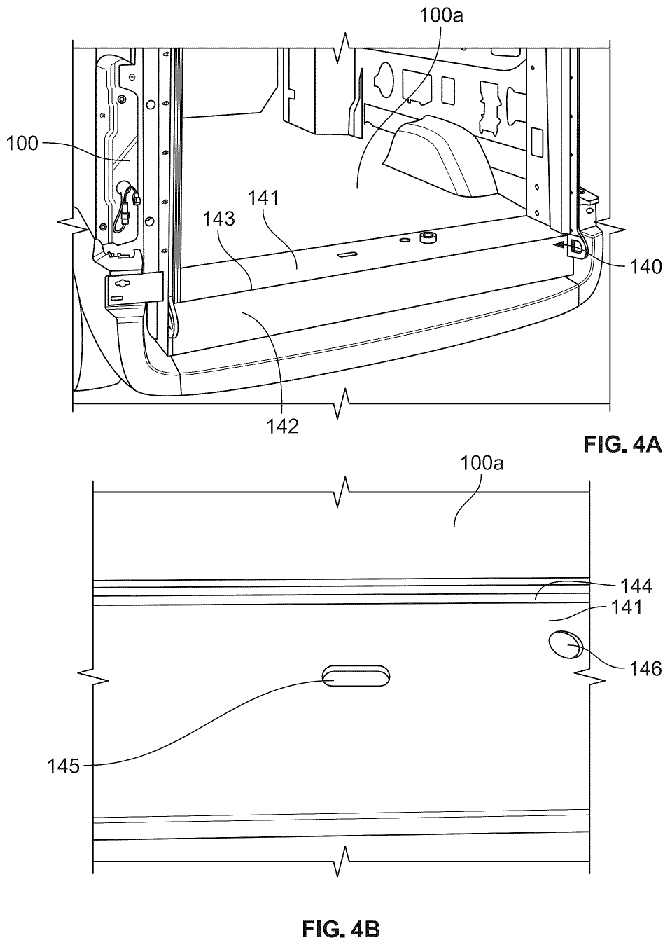

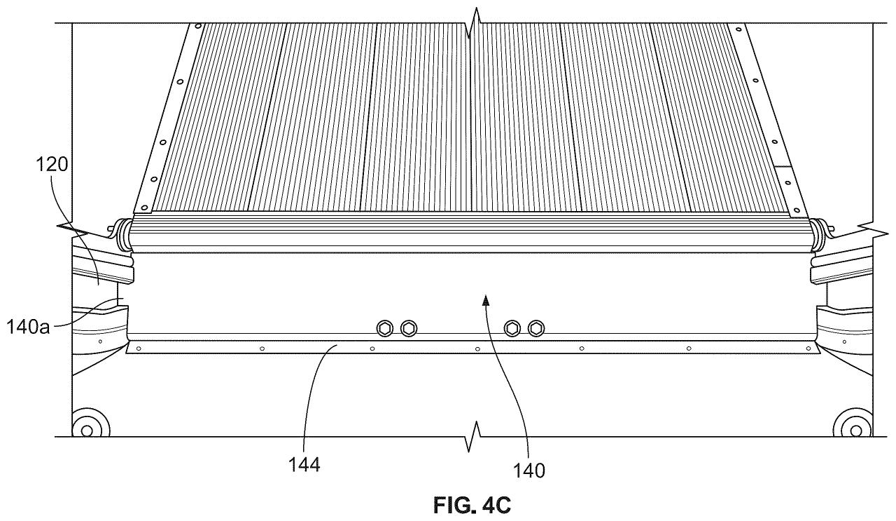

A lower plate 140 (also referred to as a lower threshold) is coupled to the body 100 and the frame 120 as shown in FIG. 4A. The lower plate 140 includes an inner surface 141 extending generally along a plane in a front-rear direction and further includes an outer surface 142 extending generally along a plane in a vertical direction, the inner surface 141 and outer surface 142 meeting at an outer edge 143. The lower plate 140 fits together with the frame 120 and ramp 110 to cover the opening 109 and prevent road debris, dirt, and water from entering the interior of the body 100. The lower plate 140 also helps to prevent a user's feet from getting stuck when stepping on the bumper, and provides a smooth transition for walking, loading or riding equipment into and out of the vehicle, as noted below. The inner surface 141 extends in a frontward direction from the outer surface 142 and terminates at an inner edge 144 which is adjacent the interior floor 100a of the body 100 as shown in FIG. 4B and is beveled in a downward direction toward the plane on which the interior floor extends. The beveled inner edge 144 helps to prevent a tripping hazard and also prevent catching an edge of a piece of equipment being loaded or unloaded.

The lower plate 140 further defines an elongate hole 145 to secure the lower plate 140 the floor of the body 100 with a fastener. The lower plate 140 also defines a circular hole 146 to access and release a spare tire stored within the body 100. As shown in FIG. 4C, sides of the lower plate 140 are contoured to snugly fit within the frame 120. For example, the lower plate 140 includes a protrusion 140a which extends laterally outward relative to adjacent surrounding surfaces of the side of the lower plate 140a, the protrusion 140a sized and shaped to fit snugly within a recess defined by surrounding surfaces, e.g., the frame 120, to close any openings therebetween.

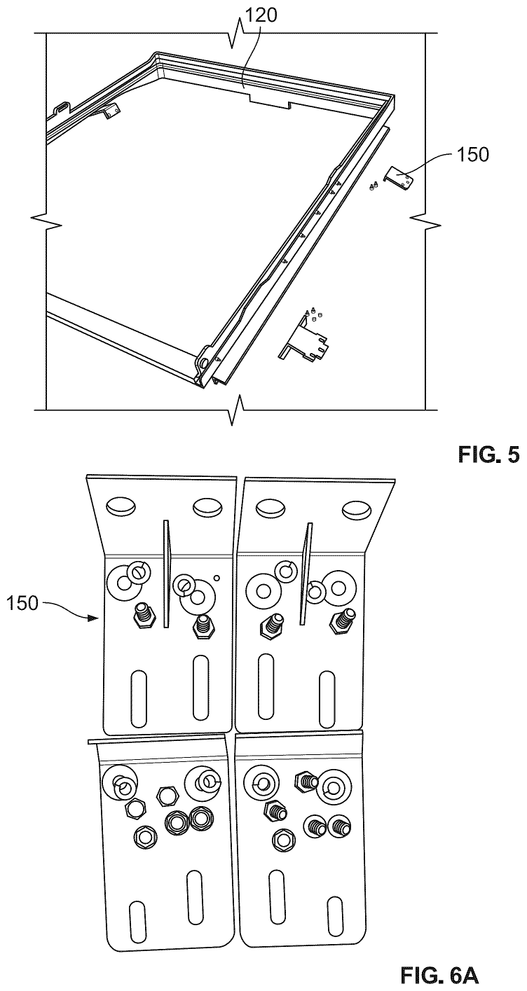

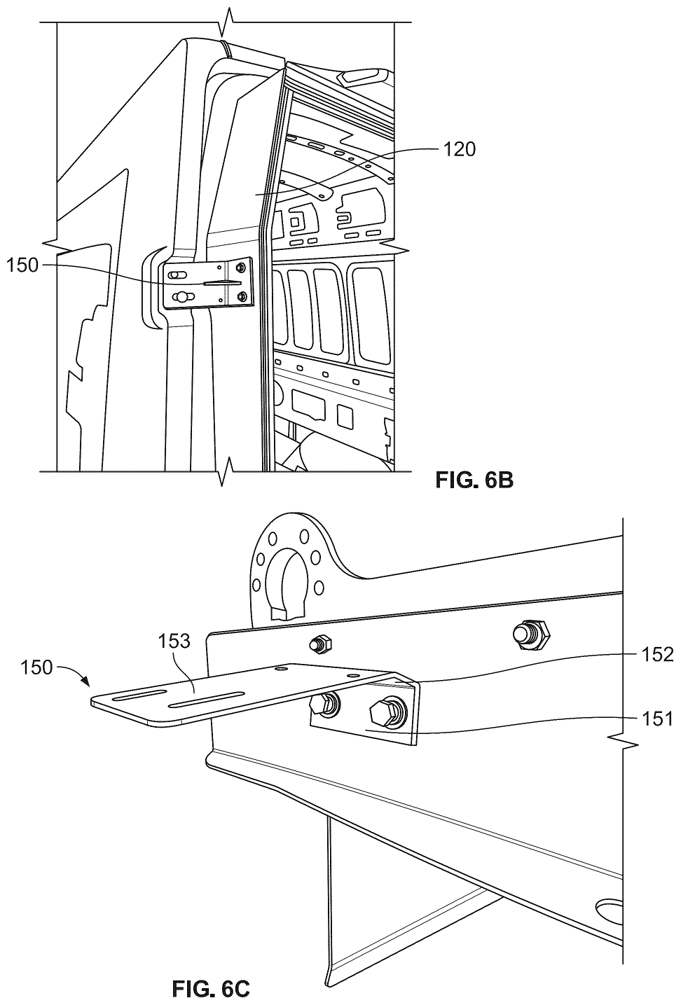

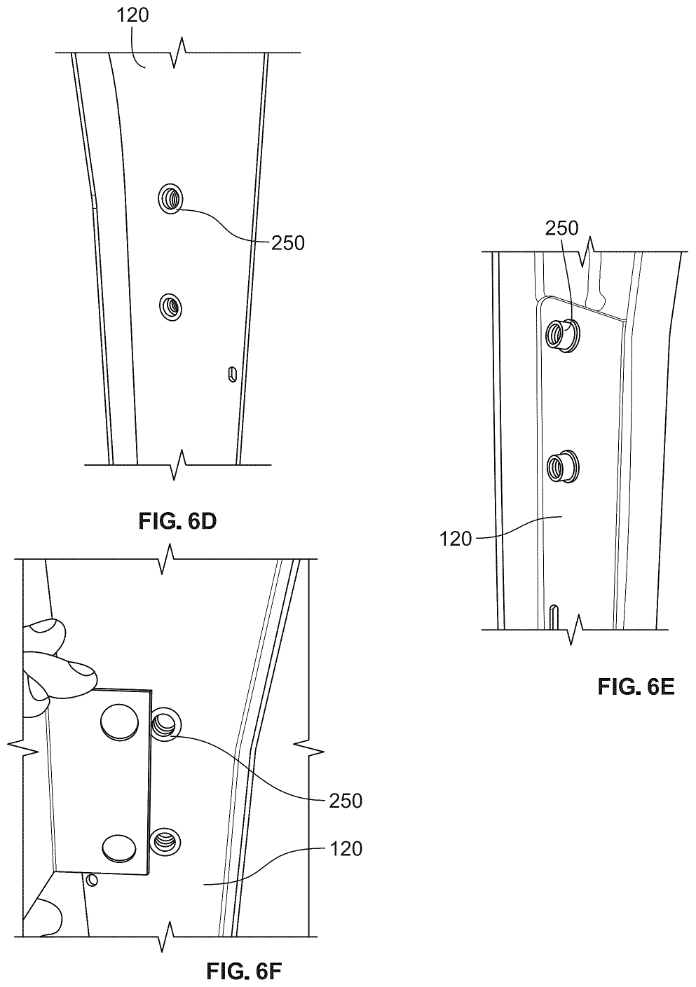

Mounting brackets 150, as shown in FIGS. 5 and 6A, are provided separately from the frame 120 in an installation kit along with a variety of fasteners and are configured to couple the frame 120 to the body 100. Providing mounting brackets 150 separately (as opposed to manufacturing the frame 120 with mounting brackets welded thereon) prevents the brackets from being damaged in transit. Additionally, in the event a bracket is damaged and needs replacing, the brackets can easily be removed and re-installed with very little effort. In some examples, as shown in FIG. 6A, the mounting brackets 150 may be generally L-shaped.

In other examples, as shown in FIG. 6C, the mounting brackets 150 are shaped to include angled portions for added strength and flexibility. That is, rather than a strictly L-shaped mounting bracket, the mounting brackets 150 may include an attachment piece 151 extending along a first plane, an intermediate piece 152 extending along a second plane forming an oblique (e.g., obtuse) angle with the first plane (whereas an L-shaped bracket would be perpendicular), and an extension piece 153 extending along a third plane forming an oblique angle with the second plane. The added flexibility of such mounting brackets 150 allows the frame 120 to be pulled in tightly and snugly against the factory weather stripping included on the originally manufactured body 100 of the vehicle 10 when fastening the fasteners into the body 100. Additionally, the angled mounting tabs 150 provide extra safety in case fasteners ever inadvertently loosen as the frame 120 would be prevented from falling away from the body 100.

In some examples, the frame 120 may be formed with pre-drilled holes and fasteners such as rivnuts installed therein to allow a user to install the mounting brackets 150 to the frame prior to the frame 120 being installed onto the body 100 of the vehicle 10. The front of the rivnut 250 may protrude very slightly beyond the surface of the frame 120 (e.g., approximately 1/64 inches) so that, when installing the ramp 110 onto the body 100, the user may rest the mounting bracket 150 over the front of the rivnut 250 to ensure a proper fit to the frame 120. When holding the mounting bracket 150 over the installed rivnuts 250, a user can see and feel when the mounting bracket 250 is correctly mounted and ready to be coupled to the frame 120. The holes are positioned on the frame 120 so as to have the mounting brackets 150 positioned to allow the frame 120 to be drawn toward the body 100 during coupling to form a tight and seamless fit.

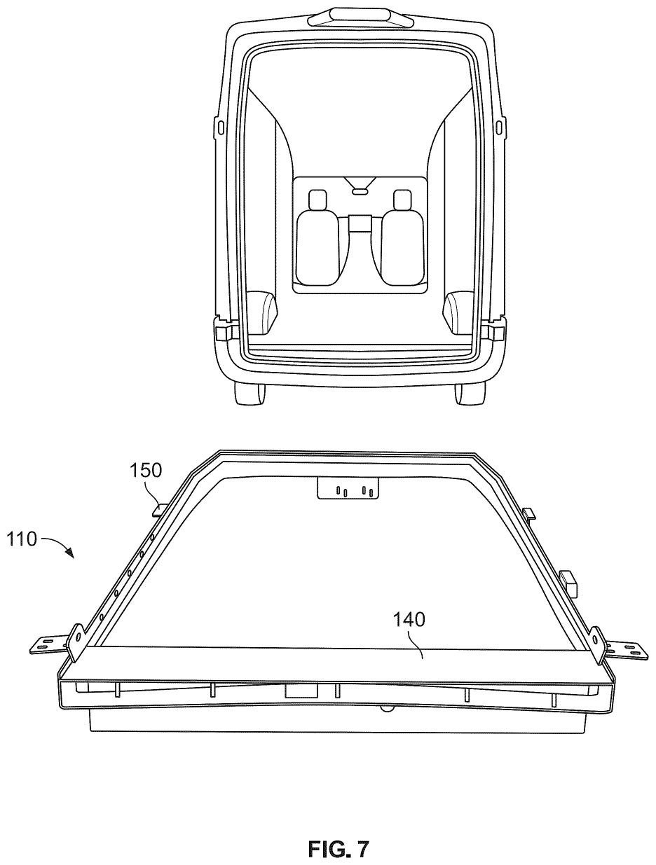

During installation of the components onto the vehicle, the frame 120, lower plate 140 and mounting brackets 150 may be assembled to one another, as shown in FIG. 7, to form a subassembly. The subassembly may then be installed onto the body 100 of the vehicle 10.

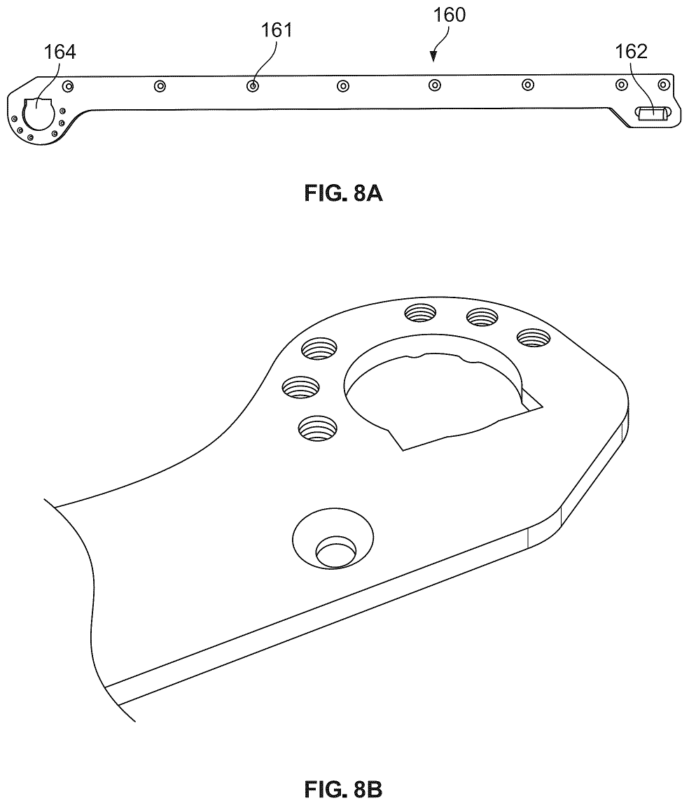

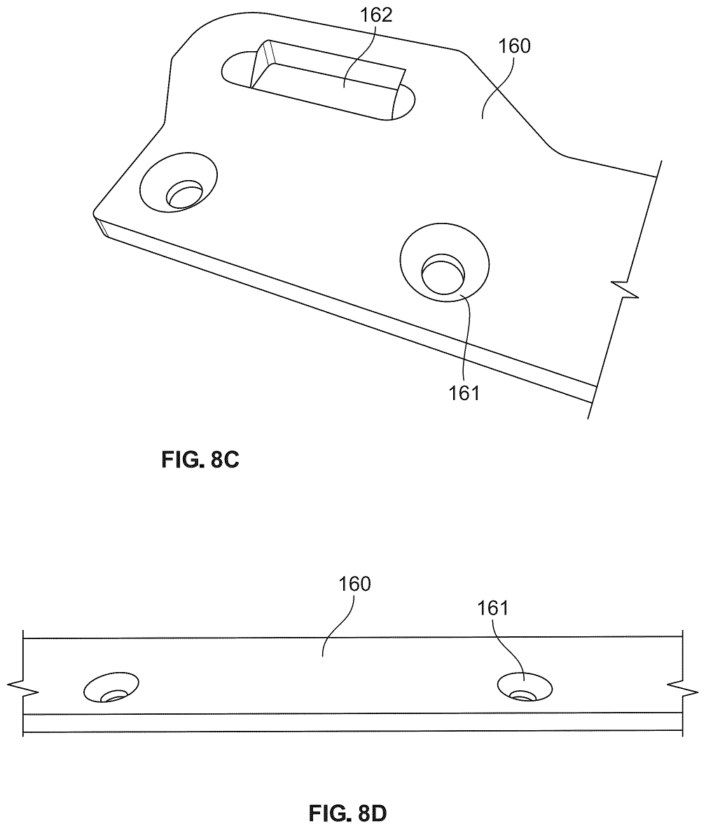

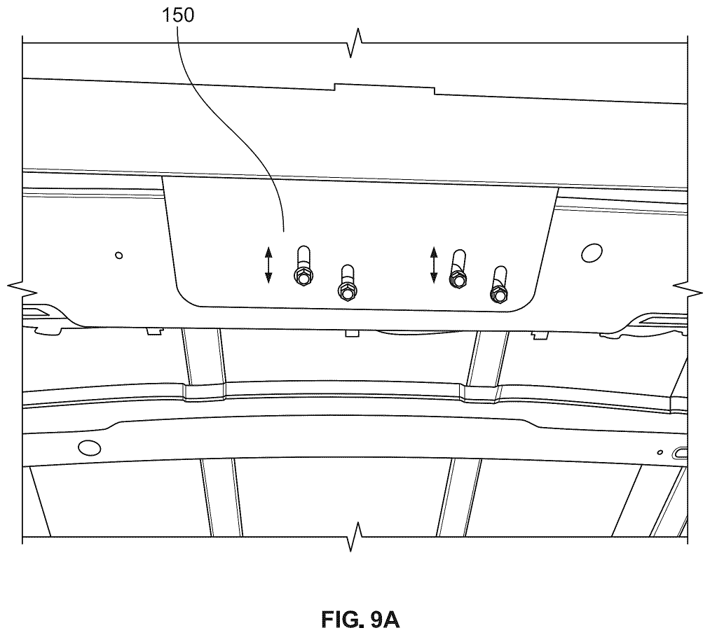

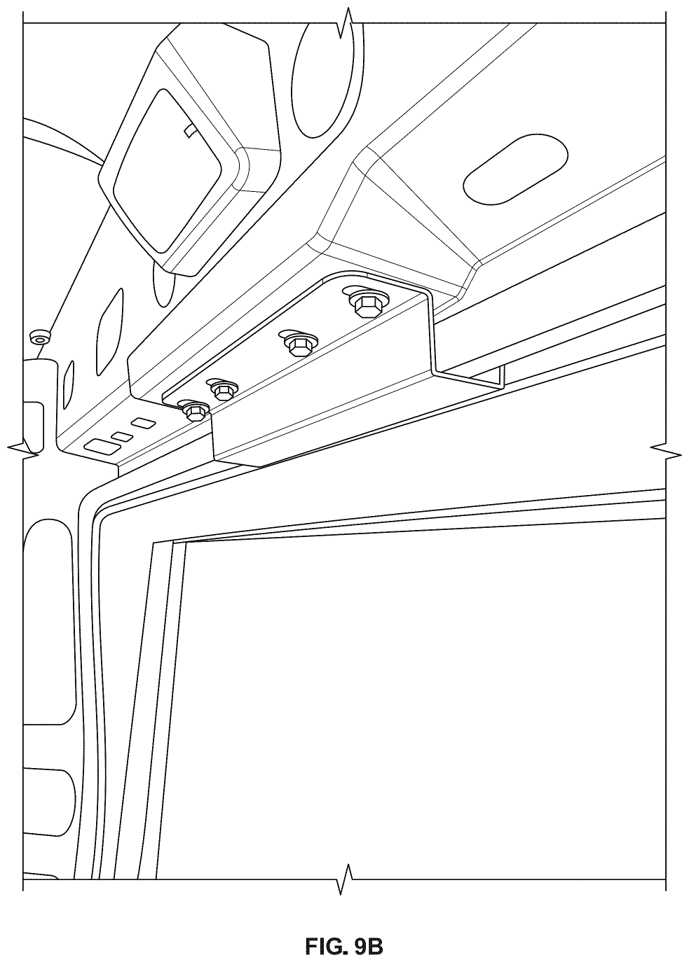

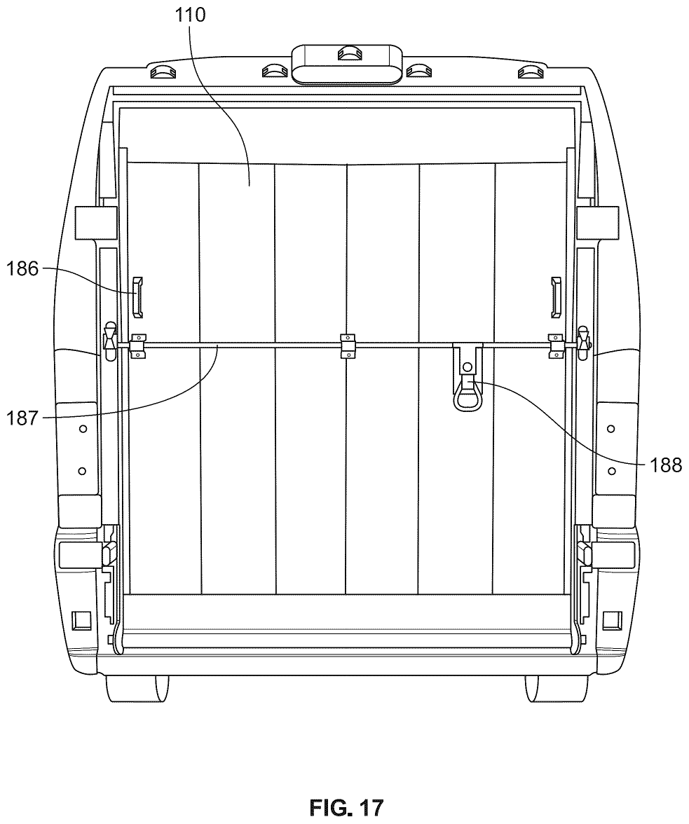

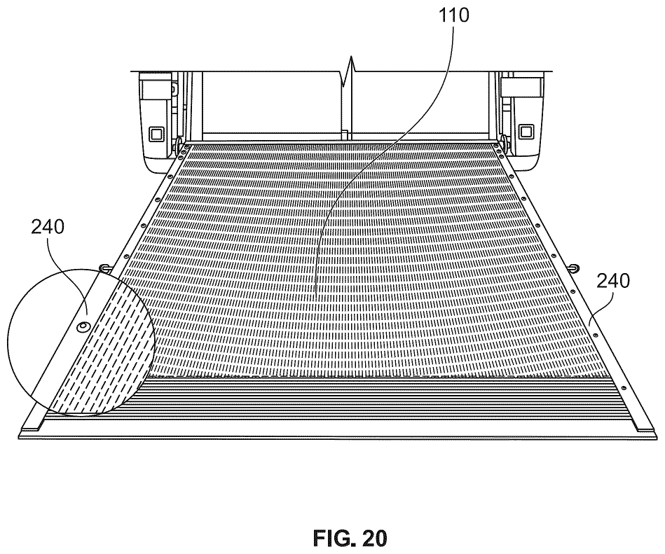

A frame bar 160, as shown in FIG. 8A, is coupled to each of the left and right sides of the frame 120 to further secure the frame 120 to the body 100. The frame bar 160 includes fastener holes 161 which are beveled for the insertion of fasteners which sit flush with the outer surface of the frame bar 160, such as counter-sunk bolts. Arranging the fasteners to be flush with the frame bar 160 prevents interference of the fasteners with the weather stripping 240 (as shown in FIG. 20 and discussed below). The frame bar 160 also includes a latch bar opening 162 which is sized and shaped to receive a latch bar 187 (shown in FIG. 17) of the vehicle 10 which secures the ramp 120 in the closed configuration. The latch bar opening 162 is also beveled to allow the latch bar 187 to slide through and maintain the ramp 120 tightly against the frame 120 when the ramp 120 is in the closed configuration. The frame bar 160 further defines a cam pin aperture 164 sized and shaped to receive cam pins 170, 175 therethrough. The attachment and positioning of the frame 160 will be discussed below in greater detail.

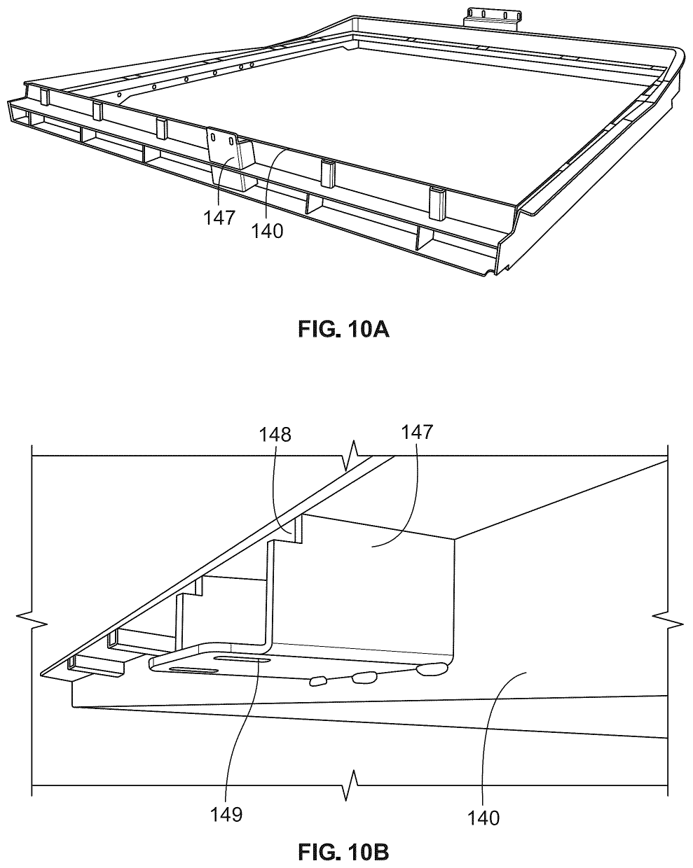

The lower plate 140 includes a lower threshold mounting bracket 147 coupled thereto (e.g., by welding). The lower threshold mounting bracket 147 extends from a lower (e.g., downward-facing) side of the inner surface 141 and a rearward-facing side of the outer surface 142, as shown in FIGS. 10A-10B. The lower threshold mounting bracket 147 defines notches 148 on upper and inner corners thereof which are configured to receive and fit against the body 100 of the vehicle 10. The notches 148 act as a stop for proper placement of the components relative to one another. The lower threshold mounting bracket 147 further defines holes 149 on a lower surface thereof which are adapted to receive fasteners to couple the lower threshold mounting bracket 147 to the body 100.

The lower threshold mounting bracket 147 is attached to the frame 120 such that it raises the bottom of the frame 120 to be level with the interior floor of the body 100, and such that the lower threshold mounting bracket 147 is generally hidden from plain view and out of the way. The design of the lower threshold mounting bracket 147 allows a user installing the frame 120 to the body 100 to hold the frame 120 in place and adjust the holes in the lower plate 140 to meet holes defined by the body 100 and then fasten the lower plate 140 into place, which cases the installation process and prevents the user from pinching or injuring hands during installation. It is also noted that the lower plate 140 is positioned within the lower end of the frame 120, which allows the user or installer to keep the bumpers in place, rather than requiring removal of the bumpers for installation.

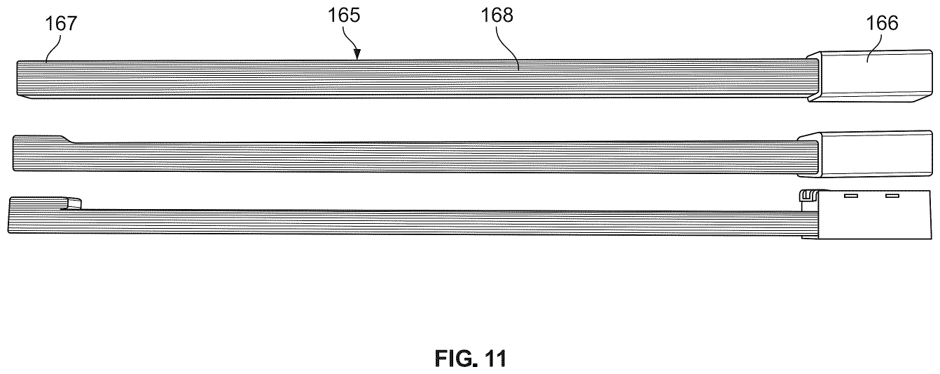

The ramp 110 further includes a spring torsion bar 165 extending between a first end 166 and a second end 167 as shown in FIG. 11. The spring torsion bar 165 helps to mitigate the weight of the ramp for the user when transitioning the ramp 110 between the closed configuration and the open configuration. The first end 166 is encased and welded to be received in a grooved cavity at the bottom of the ramp 110, as described below in greater detail. The grooves 182 inside the cavity 181 of the pivot dock 180 (described below in further detail) hold the spring torsion bar 165 in place as the torsion is increased or decreased when the ramp is transitioned between the open and closed configurations. The second end 167 is sized and shaped to be inserted into a female cam pin 175, which is described below in greater detail. The female cam pin 175 defines a socket 177 sized and shaped to receive and hold the spring torsion bar 165 in place while the spring is being activated when the ramp is transitioned between the open and closed configurations. The spring torsion bar 165 is configured to receive a plurality of straps 168 therein, which could be varied or modified to accommodate different weights.

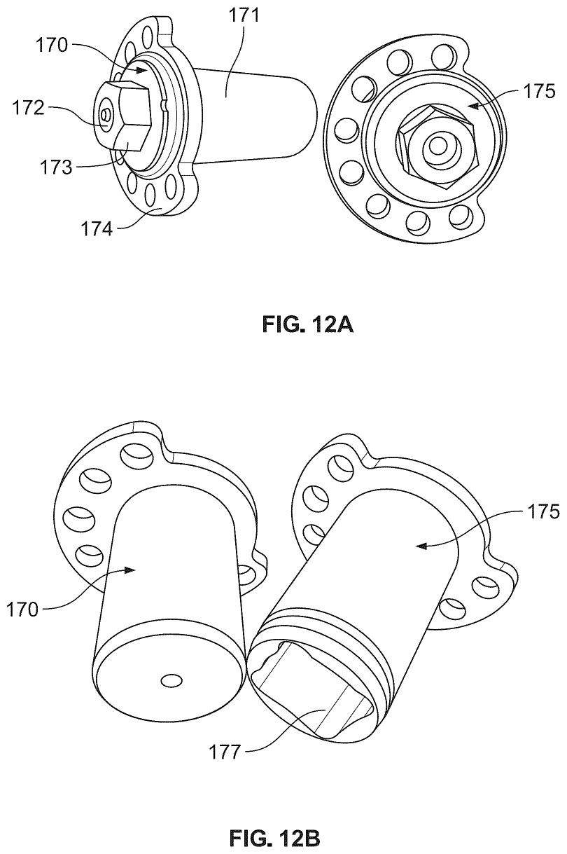

Cam pins 170, 175 hold the spring torsion bar 165 in place in the cavity 181 of the ramp pivot dock 180, which is an extruded piece fixedly coupled to the ramp 110 (e.g., by welding). Each cam pin 170, 175 includes a machined center pin 171 which is generally cylindrical, a grease fitting 172, a center bolt 173 and an outer bolt ring 174, as shown in FIG. 12A. The outer bolt ring 174 defines eight holes (but is not limited thereto). The cam pins 170, 175 are adapted to be turned clockwise or counterclockwise so that a user can rotate the cam pin to increase the torsion in the spring torsion bar 165. Moving the outer bolt ring 174 counterclockwise increases the torque providing additional weight mitigation. Moving the outer bolt ring 174 clockwise reduces the weight mitigation. The center bolt 173 allows a user to clock the entire cam pin 170, 175 in order to realign the bolt holes and secure in a different position depending upon the desired weight mitigation.

The male cam pin 170 is configured to fit on the left side of the ramp 110 and does not hold the spring torsion bar 165 in place. The male cam pin 170 slides into place and may be fastened to an end of the frame bar 160 defining the cam pin aperture 164 to hold the ramp 110 in place. The female cam pin 175, which defines a hollow cavity in the cylindrical portion 171, is sized and shaped to receive the spring torsion bar 165 within the cavity. Once in position, the female cam pin 175 is fastened into place holding the spring torsion bar 165 in the correct position so that it provides torque when transitioning the ramp 110 between the open and closed configurations.

In certain embodiments of the cam pins 170, 175, a user has to rotate the cam pin clockwise or counterclockwise in order to control the weight mitigation. When the center pins 171 are round, it can be difficult to weld them at zero degrees. Welding the cam pins 170, 175 at zero degrees ensures every cam pin produces approximately the same weight mitigation. Because of this design, if the outer bolt hole ring 174 is welded off the zero-degree mark, weight mitigation may vary from ramp to ramp. In the embodiment shown in FIG. 12C, however, the cam pins 170, 175 define a notch 176, which ensures the outer bolt hole ring 174 is placed in the zero degree position every time prior to welding. The notch 176 is a planar surface on the perimeter of the center pin 171 which intersects the rounded surfaces of the center pin 171 such that the center pin 171 generally forms a stadium shape. Furthermore, because of the notched design, the weight mitigation can be adjusted by “clocking” or “timing” the notching several degrees either way and then welding the outer bolt hole ring 174 to that exact position.

In other examples, a section of the outer ring bar 174 may be cut as shown in FIG. 12D to allow the ramp 110 to sit flat on top of the bumper of the vehicle 10. In this example, the outer ring bar 174 has a planar surface which intersects the rounded perimeter of the outer ring bar 174.

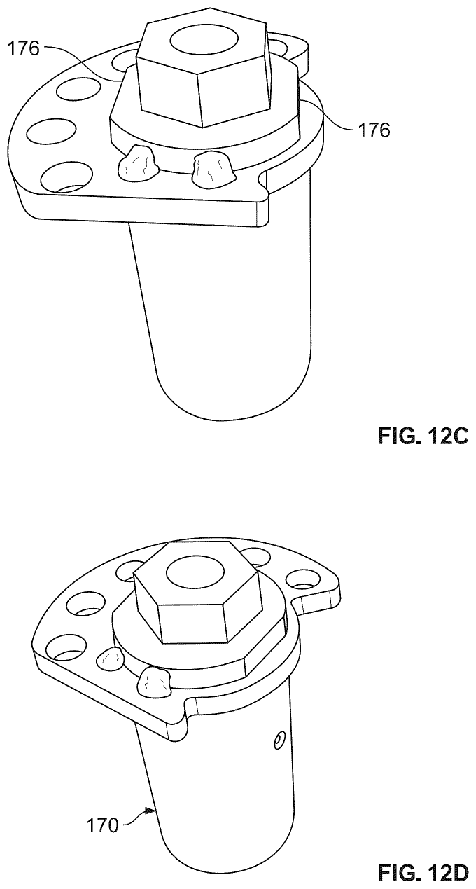

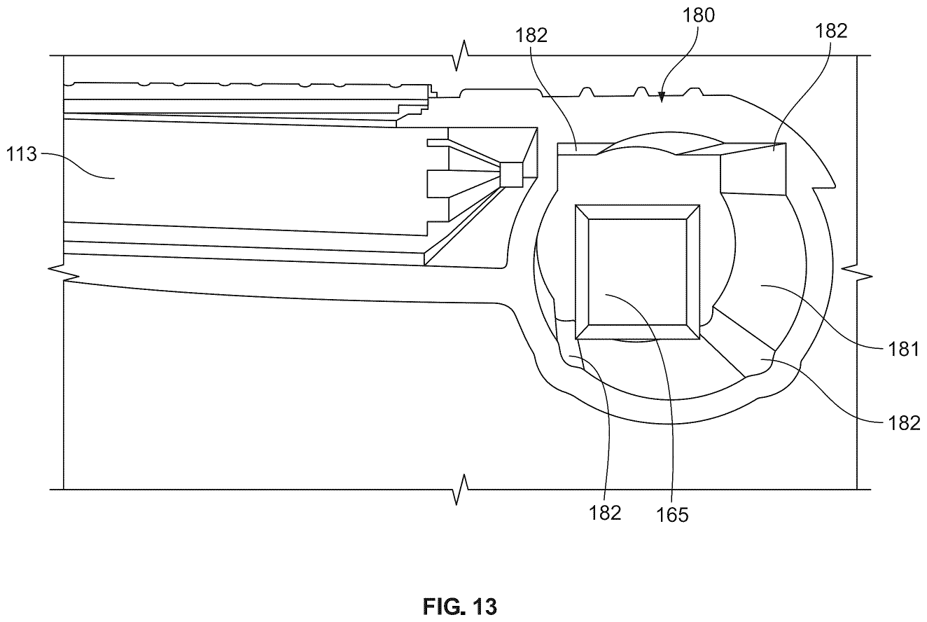

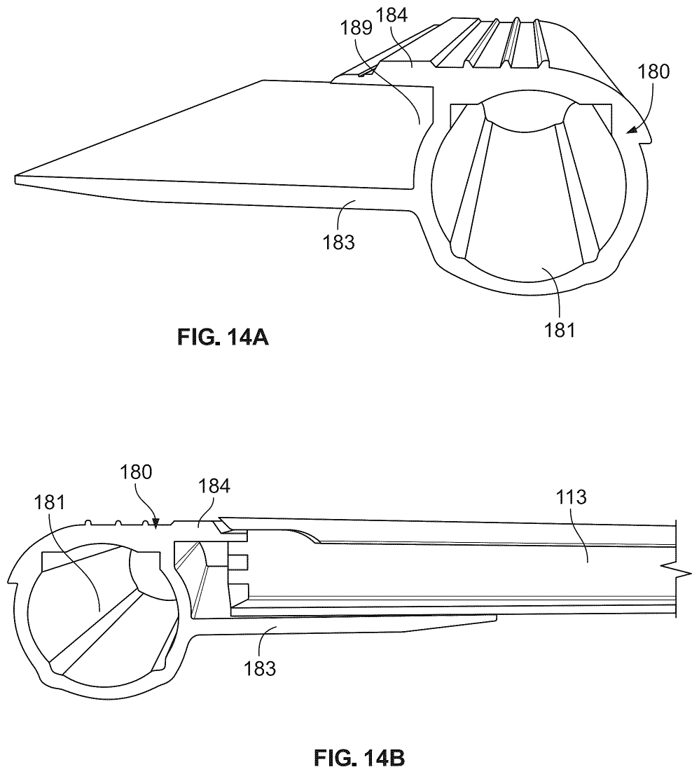

FIG. 13 illustrates a combined subassembly of the ramp pivot dock 180, a ramp panel 113 and the spring torsion bar 165. As shown in FIGS. 13 and 14A, the ramp pivot dock 180 includes a hollow cavity 181 having grooves 182, the hollow cavity 181 sized and shaped to receive the spring torsion bar 165 and the cam pins 170, 175. There are four grooves 182 spaced about equally apart and each groove 182 forms approximately a right angle within the cavity 181. The first end 166 of the spring torsion bar 165 is received into the grooves 182 to hold the spring torsion bar 165 in place. The spring torsion bar 165 has a generally square end that is configured with dimensions corresponding to fit into the grooves 182 of the hollow cavity 181. This maintains the position of the spring torsion bar 165 and allows the spring torsion bar 165 to flex and torque providing weight mitigation for the ramp 110 when transitioning between the open and closed configurations. The grooves 182 extend an entire length of the pivot dock 180, which sturdily prevents the spring torsion bar 165 from moving out of position. By holding the spring torsion bar 165 in place, the straps 168 are permitted to twist, thereby creating the torque needed to mitigate the weight of the ramp 110 while transitioning between the open and closed configurations.

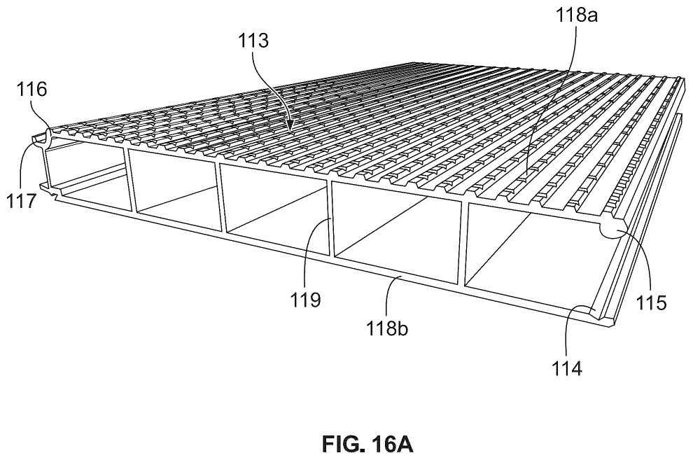

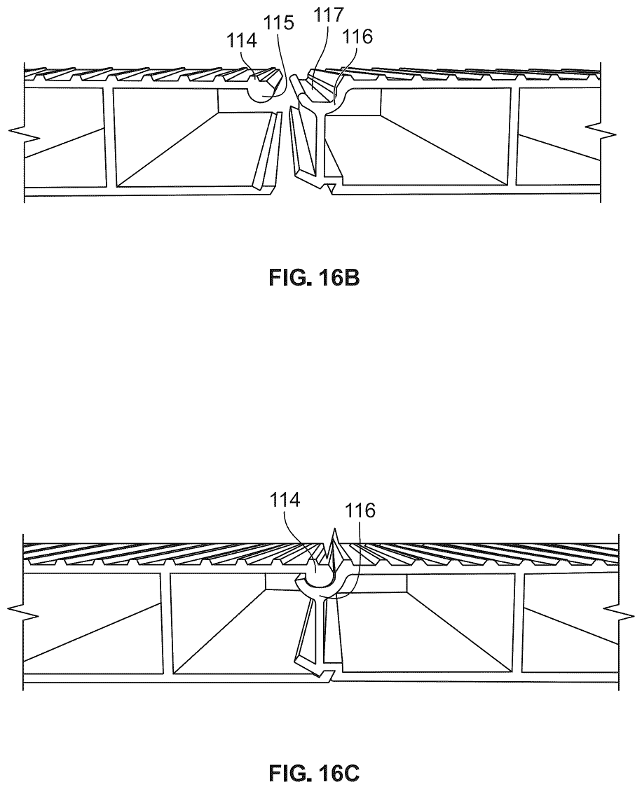

After installation of the ramp 110 on the body 100, the pivot dock 180 is positioned at a rear lower portion of the vehicle body 100 and is coupled to the ramp panels 113 (e.g., by welding) at an inner end 111 of the ramp 110. The pivot dock 180 includes lower protrusion 183 which extends from the hollow cavity 181 and couples to a portion of the outer surface of the panels 113 to mitigate stress applied to the ramp 110 during use and apply support thereto. The pivot dock 180 further includes upper protrusion 184 which is configured to be coupled to a portion of the inner side of the ramp panels 113. That is, the lower protrusion 183 extends generally parallel to and alongside at least a portion of the outer surface of the ramp panels 113 (e.g., outer sheet 118b shown in FIG. 16A), and the upper protrusion 184 extends generally parallel to and alongside at least a portion of the inner surface of the ramp panels 113 (e.g., inner sheet 118a shown in FIG. 16A). The upper protrusion 183 and the lower protrusion 184 define a slot 189 therebetween which is sized to snugly receive the ramp panels 113 therebetween to allow for permanent fixation of the pivot dock 180 to the panels 113, e.g., by welding. The lower protrusion 183 extends a first distance from the hollow cavity 181 farther than a second distance which the upper protrusion 184 extends from the hollow cavity 181 to provide greater support the outer side of the ramp 110.

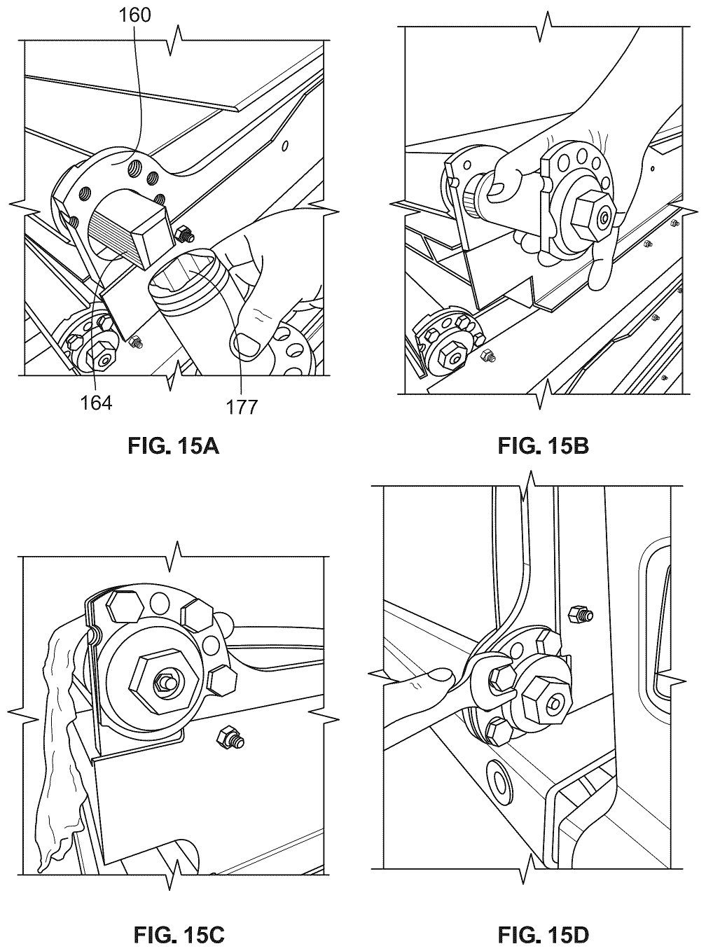

As shown in FIGS. 15A-15D, the female cam pin 175 is configured to be inserted onto the spring torsion bar 165 such that the socket 177 defined by the female cam pin 175 receives the spring torsion bar 165 therein. The female cam pin 175 is then slid through the cam pin aperture 164 of the frame bar 160 into a position such that fasteners can secure both the female cam pin 175 and the spring torsion spring bar 165 in place. That is, apertures defined by the outer ring bar 174 of the female cam pin 175 may be aligned with apertures defined by the frame bar 160 to pass fasteners therethrough for securement.

The ramp 110 is formed by the combination of ramp panels 113, the pivot dock 180, and a ramp dock 185. The ramp panels 113 may be extruded in widths between approximately 4 to 11 inches, preferably 10.25 inches, but can alternatively be extruded into any size and width needed to accommodate a desired size and width of the ramp 110. The ramp panels 113 can be extruded to any length needed to accommodate a desired size of the ramp 110 as well. Each panel 113 includes a locking side 114 and a receiving side 116 opposite the locking side 114. The locking side 114 includes a protrusion 115 sized and shaped to engage and correspond with the slot 117 defined by a C-shaped extension on the receiving side 116 of another (e.g., adjacent) panel. The shapes of the locking side 114 and the receiving side 116 of each panel 113 allows for the interlocking of adjacent panels 113 as shown in FIGS. 16A-16B in preparation for permanent fixation to one another, e.g., by welding.

As shown in FIG. 17, the ramp 110 further includes ramp handles 186, a latch bar 187, and a latch lock 188.

As noted above, the pivot dock 180 is positioned at a rear lower surface of the body 100 and at inner end 111 of the ramp 110. The ramp 110, when attached to the frame 120, pivots with respect to the pivot dock 180 when the ramp 110 is transitioned between the open and closed configurations. The pivot dock 180 couples the ramp 110 to the frame 120. Once the ramp 120 is placed into position for attachment to the frame 120, the male cam pin 170 may be inserted (e.g., on the left side of the vehicle 10) through the cam pin aperture 164 in the frame bar 160 and positioned into the hollow cavity 181 of the pivot dock 180 and then secured in place with fasteners, similar to the manner described above with respect to insertion of the female cam pin 175 but without coupling to the spring torsion bar 165. On the opposite side, (e.g., the right side of the vehicle 10), the female cam pin 175 may be inserted over the spring torsion bar 165 and then positioned into the hollow cavity 181 of the pivot dock 180 and may then be secured in place with fasteners. The pivot dock 180 may be extruded and may be between approximately 7 to 8 inches in total length, preferably 7.5 inches. A side of the pivot dock 180 may act as a brace to give the additional support needed as this section of the ramp 110 bears most of the stress load when transitioning the ramp 110 between the open and closed configurations.

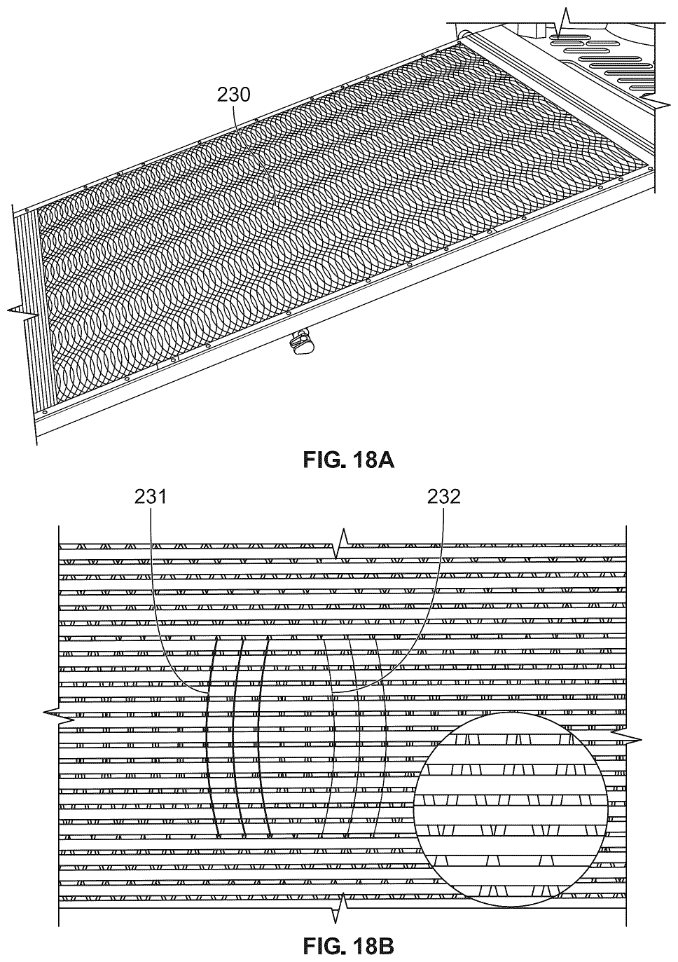

An exterior surface of the ramp 110 (i.e., the surface that faces outward when the ramp 110 is in the closed configuration) is smooth, whereas an interior surface of the ramp (i.e., the surface that faces inward toward the interior of the vehicle 10 when the ramp 110 is in the closed configuration) is machined with a concentric design that creates an anti-slip surface as shown in FIGS. 18A-18B. The interior surface 230 includes a first set of curved parallel struts 231 angled in a first direction and a second set of curved parallel struts 232 angled in a section direction opposite the first direction, wherein the first and second sets of curved parallel struts 231, 232 intersect each other forming a concentric circular pattern. The anti-slip interior surface 230 provides traction for equipment being loaded or unloaded and provides a safe surface for a user to walk on while loading and unloading. The concentric design of the anti-slip surface allows traction from all points, thereby providing traction in all directions of movement. In some examples, the interior ramp 230 surface may be routered approximately 90 degrees, which creates an edge on the top that provides the traction. The ramp panels 113 may be extruded in any size depending on the desired height and width of the ramp 110.

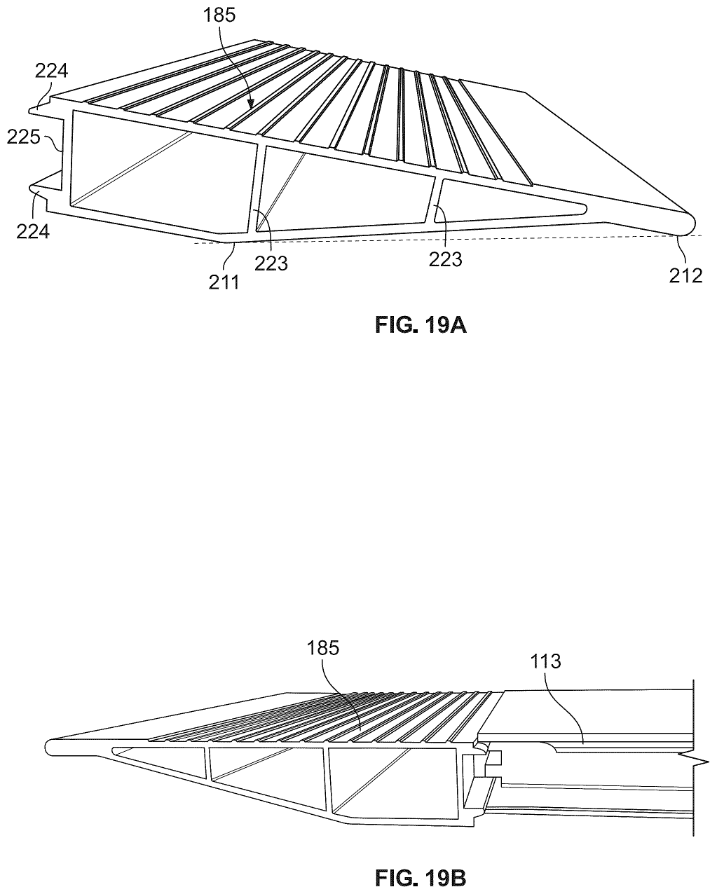

The ramp dock 185, shown in FIGS. 19A-19B, may be formed (e.g., extruded) with a slight angle at the end so that the ramp 110 lays substantially flush to the ground when in the open configuration. That is, the ramp dock 185 may have an inner foot 221 and an outer foot 222 which are tangential to a common plane such that the inner foot 221 and the outer 222 can rest on the ground simultaneously when the ramp 110 is in the open configuration. The ramp dock 185 may be between approximately 6 to 8 inches in thickness, preferably about 7 inches, and can be extruded to any length as needed. The ramp dock 185 includes ribs 223, similar to the ribs 119 of the ramp panels 113, for weight support. The ramp dock 185 includes inner lips 224 which define a groove 225 sized and shaped to receive the panels 113 to couple the ramp dock 185 to the panels 113.

In other examples, the ramp dock may be formed (e.g., extruded) with multiple extended angles to decrease the pitch of the ramp. For example, the ramp dock may be formed with an extended facia (larger) on the side of the ramp dock that rests on the ground after opening. By extruding a ramp dock with an extended facia, the pitch of the ramp would be modified. Approximately, every inch added to the ramp dock decreases the pitch by about 2°-4°. Lower pitch, promotes case of moving equipment in and out of the vehicle.

Each ramp panel 113 includes an inner sheet 118a extending generally along a first plane, an outer sheet 118b extending generally along a second plane parallel to the first plane, and a rib 119 extending from the inner sheet 118a to the outer sheet 118b generally perpendicular to the first and second planes. The ribs 119 may be spaced between approximately 1.5 inches to 2.5 inches apart from each other, preferably about 2 inches. The ramp panels 113 further include the locking and receiving sides 114, 116 as noted above. The structure of the ramp panel 113 provides improved strength to the entire ramp platform, allowing for a greater weight capacity, e.g., allowing a weight rating capacity of 2,200 pounds. The interlocking panels provide additional support so that the ramp 110 will not flex or bounce during loading and unloading. The interlocking panels additionally allow the panels to remain tight and secure during the welding process. The interlocking structure of the ramp panels 113 eliminates the need for welding the panels together, and thus only welding may be needed where the pivot and ramp dock are installed at the top and bottom of the ramp, thus sparing labor and expense in manufacturing.

The sides of the ramp panels 113 may be covered by side strips 240 that serve to cover the open sides of the ramp as shown in FIG. 20 to prevent water and debris from entering the interior of the vehicle 10 through the sides of the ramp 110. The side strips 240 may be coupled to the inner and outer surfaces (e.g., inner sheet 118a and outer sheet 118b) of the ramp panels 113, e.g., by riveting. The side strips 240 may be formed of aluminum.

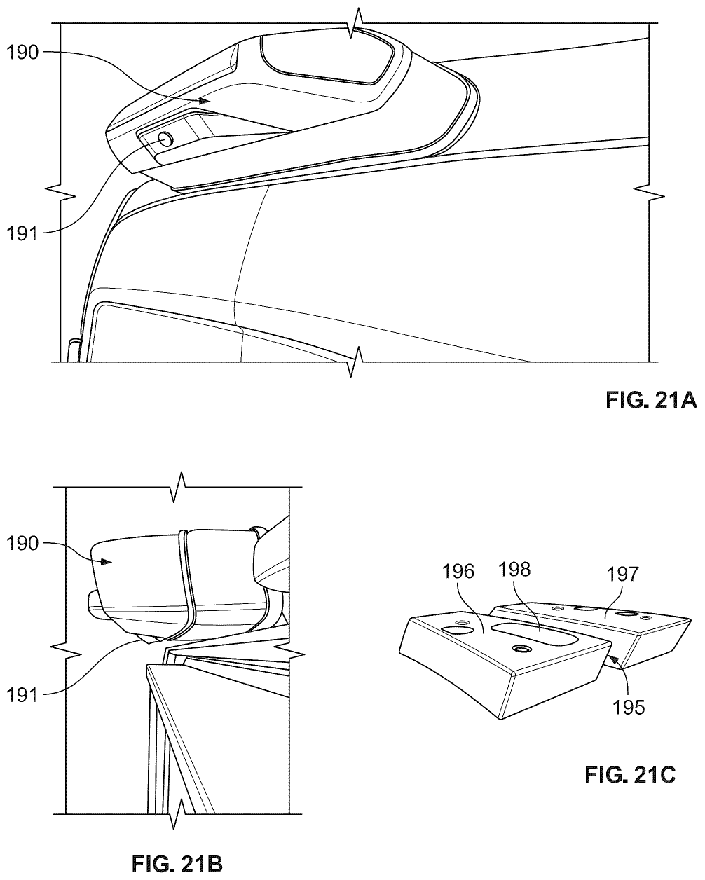

The vehicle 10 includes a rear camera extension 190 illustrated in FIGS. 21A-21B which is positioned on an upper portion of the vehicle 10 and protrudes in a rearward direction relative to the rear face of the body 100. The upper end 123 of the frame 120 of the present invention acts as a gutter and may block vision of the conventional camera used for backing up. Thus, the rear camera extension 190 is included to position a camera eye 191 spaced from the body 100 and from the frame 120 to prevent blockage of the camera's view by the frame 120. The rear camera extension 190 may be produced using blow-injection to create a precise desired form and fit. The rear camera extension 190 may be made from ABS plastic and may have UVA and UVB inhibitors to protect it from the sun and elements.

In some examples, a rear camera extension 195 according to another embodiment of the disclosure includes a first extension piece 196 and a second extension piece 197 spaced from the first extension piece 196, as shown in FIG. 21C. The first extension piece 196 is configured to hold the taillight of the vehicle 10 as originally included during construction of the vehicle 10 and further defines apertures for fastening to the body 100. The second extension piece 197 defines an aperture 198 for holding a wiring harness. Each extension piece 196, 197 has a curved bottom surface which is configured to abut the body 100 to be form-fitted.

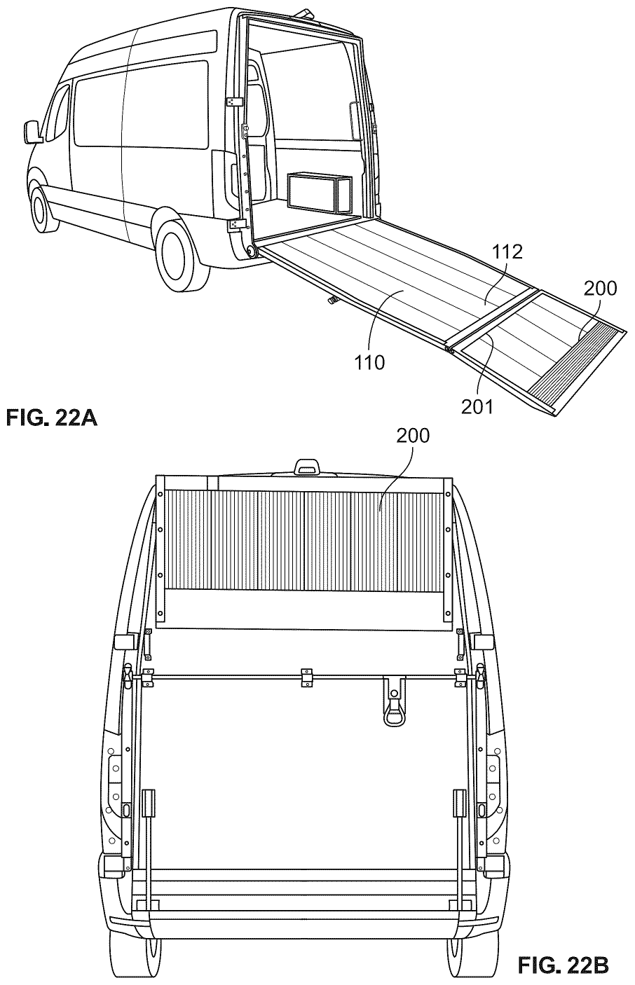

In some examples, the ramp 110 may include a ramp extension 200, as shown in FIGS. 22A-22B. The ramp extension 200 may be fixedly coupled to the outer end 112 of the ramp 110 to prolong a total length of the ramp 110 and also reduce the pitch or angle formed between the ramp 110 and the ground. For example, the pitch of the ramp 110 without the ramp extension 200 may range from approximately 22 degrees to 24 degrees, whereas the inclusion of a ramp extension 200 measuring approximately three feet in length reduces the pitch to approximately 6 degrees, which may make loading and unloading a safer process. The reduced pitch may prevent or reduce the chance of equipment from tipping over, and the ramp extension 200 may provide additional loading platform space to center equipment and dollies prior to loading and unloading.

The ramp extension 200 is hingedly coupled to the outer end 112 of the ramp 110 such that it is configured to fold toward an outer (e.g., rearward) side of the body 100 when in a closed position. The ramp extension 200 may unfold or be unfolded into its extended form as the ramp 110 is lowered down into the open position. In some examples, the ramp extension 200 may be coupled to the ramp 110 by welding in the form of piano hinging. That is, there are four hinges that are welded into place across the outer end 112 of the ramp 110 to secure and add strength to the hinge. An inner end 201 of the ramp extension 200 may rest against the outer end 112 of the ramp 110 when in the open configuration, which also acts to keep the ramp 110 from folding beyond the hinged section when fully opened.

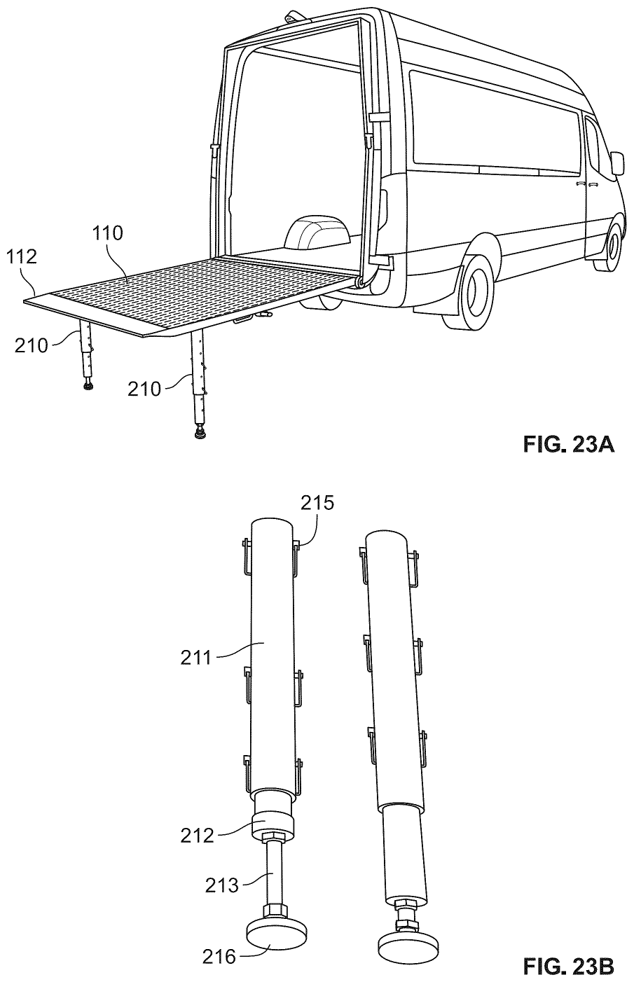

As shown in FIGS. 23A-23B, legs 210 may be removably coupled to the ramp 110 when the ramp 110 is in the open configuration to raise the outer end 112 of the ramp 110 such that the outer end 112 is spaced from the ground and the ramp 110 is at rest in a plane that is generally horizontal or parallel to the ground. This allows the ramp 110 to be used as a worktable or have any other similar use for a raised flat surface. The legs 210 may be formed of high-strength aluminum. Each leg 210 may include two tubes 211, 212 which slide into each other and can be adjusted relative to one another to modify the length of the leg 210. Once a desired length is established, the tubes 211, 212 may be secured relative to one another, e.g., by inserting aluminum pins 215 with hooked loops. Each pin may have a shear rating of approximately 5,000 pounds. In some examples, a threaded shaft 213 may be coupled into the legs 210, e.g., by welding, to allow for further adjustment of lengths of the legs 210 but rotating the threaded shaft 213. The bottoms of the legs 210 may have gimbled feet 216 which are configured to adjust to different slopes to improve the leveling of the worktable.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A frame assembly for a vehicle with a built-in ramp, comprising:
a frame configured to bound an opening of a vehicle, the frame comprising:
a first leg extending between a first end and a second end;
a second leg extending between a first end and a second end; and
a bridge extending between the first end of the first leg and the first end of the second leg;
each of the first and second legs extending from an inner surface to an outer surface, the inner surface configured to abut a body of the vehicle, and the outer surface configured to abut a built-in ramp when the ramp is in a closed configuration;
wherein the outer surface of each of the first and second legs is substantially planar, and
wherein the inner surface of each of the first and second legs is tapered such that the inner surface is contoured to the body of the vehicle.

2. The frame assembly of claim 1, wherein the inner surface and the outer surface of the first and second legs are separated by a depth of the first and second lengths extending in a front-rear direction when the frame assembly is coupled to the vehicle,
wherein the first leg includes an upper tapered portion, a central portion adjacent and below the upper tapered portion, and a lower tapered portion adjacent and below the central portion,
wherein the inner surface of the first leg tapers toward the outer surface as the first leg extends from the upper tapered portion toward the central portion,
and wherein the inner surface of the first leg tapers toward the outer surface as the first leg extends from the lower tapered portion toward the central portion.

3. The frame assembly of claim 1, wherein the first leg includes an upper tapered portion, a central portion below the upper tapered portion, and a lower tapered portion below the central portion, and wherein the central portion has a depth defined in a front-rear direction, the depth of the central portion being less than a depth of the upper and lower tapered portions.

4. The frame assembly of claim 1, wherein each of the first leg, the second leg, and the bridge is formed with a first frame segment extending along a height of the first and second legs and a width of the bridge, the first frame segment coupled to a second frame segment extending along the height of the first and second legs and the width of the bridge and coupled to the first frame segment to form an L-shaped joint.

5. The frame assembly of claim 4, wherein a cross-section of the first leg along a horizontal plane defines the L-shaped joint between the first and second frame segments, and wherein a cross-section of the bridge along a vertical plane defines the L-shaped joint between the first and second frame segments.

6. The frame assembly of claim 4, wherein the L-shaped joint defines an interior slot between the first frame segment and the second frame segment, and wherein at least one tab is affixed to the first and second frame segments within the interior slot.

7. The frame assembly of claim 1, further comprising a flange configured to be coupled to an upper surface of the bridge of the frame, the flange configured to extend in a rearward direction from the frame and an upward direction from the frame.

8. The frame assembly of claim 1, further comprising a lower plate opposite the bridge extending between the first leg and the second leg, the lower plate including an inner surface configured to extend substantially parallel to a floor of the vehicle, the lower plate further including an outer surface extending oblique to the inner surface, such that the inner surface and the outer surface meet to define an outer edge.

9. The frame assembly of claim 8, wherein the inner surface of the lower plate includes an inner edge configured to be positioned adjacent the floor of the vehicle, and wherein the inner edge is beveled toward a plane on which the floor extends when the lower plate is coupled to the vehicle to form a smooth transition between the floor and the inner surface.

10. A vehicle with a built-in ramp, comprising:
a vehicle body extending from a front end to a rear end, the vehicle body defining an opening spanning between an upper edge of the vehicle body and a lower edge of the vehicle body;
a ramp hingedly coupled to the rear end of the vehicle body, wherein the ramp is configured to transition between an open configuration and a closed configuration,
wherein in the open configuration, the ramp protrudes in a rearward direction from the vehicle body; and
wherein in the closed configuration, the ramp is in contact with the upper edge of the vehicle body and the lower edge of the vehicle body and spans across an entirety of the opening; and
the frame of claim 1.

11. A frame assembly for a vehicle with a built-in ramp, comprising:
a frame including a first leg, a second leg, and a bridge extending between the first leg and the second leg;
a lower plate extending between the first leg and the second leg;
a pivot dock pivotably coupleable to the frame, the pivot dock defining a cavity extending therethrough;
a frame bar configured to be fastened to the frame and the pivot dock and defining an aperture for receiving a spring torsion bar therethrough;
the spring torsion bar configured to be positioned within the cavity of the pivot dock;
a cam pin configured to be positioned within the cavity of the pivot dock, the cam pin having a first rounded surface and a second rounded surface opposite the first rounded surface, and the cam pin further having a first planar surface connecting the first and second rounded surfaces and a second planar surface opposite the first planar surface and connecting the first and second rounded surfaces.

12. The frame assembly of claim 11, wherein the lower plate includes an inner surface configured to extend substantially parallel to a floor of the vehicle when the frame assembly is coupled to the vehicle, the lower plate further including an outer surface extending oblique to the inner surface, such that the inner surface and the outer surface meet to define an outer edge.

13. The frame assembly of claim 12, wherein the lower plate includes a lower mounting bracket configured to abut a body of the vehicle when the frame assembly is coupled to the vehicle, the lower mounting bracket extending in a rearward direction from the outer surface of the lower plate when the frame assembly is coupled to the vehicle and in a downward direction from the inner surface of the lower plate when the frame assembly is coupled to the vehicle, and the lower mounting bracket defining a notch on an upper-rear corner of the lower mounting bracket.

14. The frame assembly of claim 11, wherein the cam pin is a female cam pin defining a socket therein configured to receive the spring torsion bar, and wherein the frame assembly further includes a male cam pin configured to be coupled to the pivot dock on a side of the pivot dock opposite that of the female cam pin.

15. The frame assembly of claim 11, wherein the pivot dock includes a first protrusion extending a first distance from the cavity and the pivot dock includes a second protrusion extending a second distance from the cavity, wherein the second distance is greater than the first distance, and wherein the first and second protrusions extend parallel to one another and define a slot therebetween configured to receive a panel of the foldable ramp.

16. The frame assembly of claim 11, wherein the aperture defined by the frame bar is a first aperture, wherein the frame bar further defines a second aperture sized and shape to receive a latch configured to lock the ramp in the closed configuration, and the frame bar defines a plurality of orifices sized and shape to receive a fastener for coupling the frame bar to the frame, and wherein a perimeter of each of the first aperture, the second aperture, and the plurality of orifices is beveled.

17. The frame assembly of claim 11, wherein the cavity of the pivot dock is substantially cylindrical, and wherein the cavity includes a plurality of grooves configured to receive the spring torsion bar, each of the plurality of grooves substantially forming a right angle.

18. A vehicle with a foldable ramp, comprising:
a vehicle body extending from a front end to a rear end, the vehicle body defining an opening spanning between an upper edge of the vehicle body and a lower edge of the vehicle body;
a ramp hingedly coupled to the rear end of the vehicle body, wherein the ramp is configured to transition between an open configuration and a closed configuration,
wherein in the open configuration, the ramp protrudes in a rearward direction from the vehicle body; and
wherein in the closed configuration, the ramp is in contact with the upper edge of the vehicle body and the lower edge of the vehicle body and spans across an entirety of the opening; and
the frame assembly of claim 11.

19. A vehicle with a built-in ramp comprising:
a vehicle body extending from a front end to a rear end, the vehicle body defining an opening spanning between an upper edge of the vehicle body and a lower edge of the vehicle body;
a ramp hingedly coupled to the rear end of the vehicle body, wherein the ramp is configured to transition between an open configuration and a closed configuration,
wherein in the open configuration, the ramp protrudes in a rearward direction from the vehicle body; and
wherein in the closed configuration, the ramp is in contact with the upper edge of the vehicle body and the lower edge of the vehicle body and spans across an entirety of the opening;
a frame bounding the opening, the frame including a first leg, a second leg, and a bridge extending between the first and second legs, each of the first and second legs extending from an inner surface to an outer surface, the inner surface configured to abut the vehicle body, and the outer surface configured to abut the ramp when the ramp is in the closed configuration,
wherein the outer surface of each of the first and second legs is substantially planar, and
wherein the inner surface of each of the first and second legs is tapered such that the inner surface is contoured to the vehicle body.

20. The vehicle of claim 19, further comprising:
a ramp extension pivotably coupled to an outer end of the ramp, wherein when the ramp is in the open configuration, the ramp extension is coplanar with the ramp, and wherein when the ramp is in the closed configuration, the ramp extends in a first plane and the ramp extension extends in a second plane spaced from and parallel to the first plane.
